(19) United States
(12) Patent Application Publication
(10) Pub. No.: US 2005/0225513 A1
(43) Pub. Date: Oct. 13, 2005

(54) Plasma display device and method of driving the same

(75) Inventors: Yun Kwon Jung, Gyeongsangbuk-do (KR); Hee Chan Yang, Busan (KR); Ju Won Seo, Gyeongsangbuk-do (KR); Bong Koo Kang, Gyeongsangbuk-do (KR); Jin Young Kim, Daegu (KR)

Correspondence Address: MCKENNA LONG & ALDRIDGE LLP, 1900 K STREET, NW, WASHINGTON, DC, 20006, US

(73) Assignee: LG Electronics Inc., Seoul (KR)

(21) Appl. No.: 11/097,372

(22) Filed: Apr. 4, 2005

(30) Foreign Application Priority Data
Apr. 2, 2004 (KR) 10-2004-0022816
Nov. 11, 2004 (KR) 10-2004-0092135
Nov. 19, 2004 (KR) 10-2004-0095452
Mar. 7, 2005 (KR) 10-2005-0018887

(51) Int. Cl. G09G 3/28

(52) U.S. Cl. 345/63

(57) ABSTRACT

The present invention relates to a plasma display apparatus and method of driving the same, wherein erroneous discharge, miss-discharge and abnormal discharge are prevented, dark room contrast is increased, and operational margin is widened. According to the plasma display apparatus and driving method thereof, a negative voltage is applied to a first electrode, and a positive voltage is applied to a second electrode, whereby wall charges of a positive polarity are accumulated on the first electrode and wall charges of a negative polarity are accumulated on the second electrode, within discharge cells during a pre-reset period. The discharge cells are then initialized using the wall charge distribution of the discharge cells during a reset period.

### CROSS-REFERENCES TO RELATED APPLICATIONS

This Nonprovisional application claims priority under 35 U.S.C. § 119(a) on Patent Application No. 10-2004-0022816 filed in Korea on Apr. 2, 2004, Patent Application No. 10-2004-0095452 filed in Korea on Nov. 19, 2004, and Patent Application No. 10-2004-0092135 filed in Korea on Nov. 11, 2004, and Patent Application No. 10-2005-0018887 filed in Korea on Mar. 7, 2005, the entire contents of which are hereby incorporated by reference.

### BACKGROUND OF THE INVENTION

1. Field of the Invention

The present invention relates to a plasma display apparatus, and more particularly, to a plasma display apparatus and method of driving the same, wherein erroneous discharge, miss-discharge and abnormal discharge are prevented, dark room contrast is increased, and operational margin widens.

2. Background of the Related Art

A plasma display panel (hereinafter, referred to as “PDP”) is adapted to display an image by light-emitting phosphors with ultraviolet light generated during the discharge of a mixture of inert gas such as He+Xe, Ne+Xe or He+Ne+Xe. PDPs can be easily made thin and large. The image quality of PDPs has gradually improved with the help of recent developments of relevant technologies.

In order to implement the gray scale of an image, a PDP is time-driven with one frame being divided into several sub-fields having a different number of emissions. Each of the sub-fields is divided into a reset period for initializing the entire screen, an address period for selecting a scan line and selecting a discharge cell from the selected scan line, and a sustain period for implementing the gray scale depending upon the number of discharging. For example, if it is desired to display an image with 256 gray scales, a frame period (16.67 ms) corresponding to 1/60 seconds is divided into eight sub-fields SF1 to SF8, as shown in FIG. 1. Further, each of the eight sub-fields SF1 to SF8 is subdivided into an initialization period, an address period and a sustain period. At this time, the initialization period and the address period of each of the sub-fields are the same every sub-field, whereas the sustain period and the number of sustain pulses allocated thereto increases in the ratio of 2ⁿ (n=0, 1, 2, 3, 4, 5, 6, 7) in each sub-field.

FIG. 2 is a view schematically showing the arrangements of electrodes of a three-electrode AC surface discharge type PDP in the prior art.

Referring to FIG. 2, the conventional three-electrode AC surface discharge type PDP includes scan electrodes Y1 to Yn and sustain electrodes Z formed on an upper substrate, and address electrodes X1 to Xm formed on a lower substrate in such a way to intersect the scan electrodes Y1 to Yn and the sustain electrodes Z.

Discharge cells 1 for displaying one of red, green and blue visible rays are formed at the intersections of the scan electrodes Y1 to Yn, the sustain electrodes Z and the address electrodes X1 to Xm.

A dielectric layer (not shown) and a MgO protection layer (not shown) are formed on the upper substrate in which the scan electrodes Y1 to Yn and the sustain electrodes Z are formed.

Further, barrier ribs for preventing optical and electrical interference among neighboring cells 1 are formed on the lower substrate in which the address electrodes X1 to Xm are formed. Phosphors, which are excited by ultraviolet rays to emit visible rays, are formed on the surface of the lower substrate and the barrier ribs.

A mixturee of inert gas such as He+Xe, Ne+Xe or He+Xe+Ne is injected into discharge spaces defined between the upper substrate and the lower substrate of the PDP.

FIG. 3 shows a driving waveform supplied to the PDP as shown in FIG. 2. The driving waveform of FIG. 3 will be described with reference to the distribution of wall charges shown in FIGS. 4a to 4e.

Referring to FIG. 3, each of sub-fields SFn−1, SFn includes a reset period RP for initializing the discharge cells 1 of the entire screen, an address period AP for selecting a discharge cell, a sustain period SP for sustaining discharging of a selected discharge cell 1, and an erase period EP for erasing wall charges within the discharge cell 1.

In the erase period EP of the (n−1)^{th} sub-field SFn−1, an erase ramp waveform ERR is applied to the sustain electrodes Z. During the erase period EP, 0V is applied to the scan electrodes Y and the address electrodes X. The erase ramp waveform ERR is a positive ramp waveform whose voltage gradually rises from 0V to a positive sustain voltage Vs. Erase discharge occurs between the scan electrodes Y and the sustain electrodes Z within on-cells in which the sustain discharge is generated by the erase ramp waveform ERR.

Wall charges within the on-cells are erased by the erase discharge. As a result, each of the discharge cells 1 has wall charge distribution, as shown in FIG. 4a, immediately after the erase period EP.

In a set-up period SU of the reset period RP where the n^{th} sub-field SFn begins, a positive ramp waveform PR is applied to all the scan electrodes Y, and 0V is applied to the sustain electrodes Z and the address electrodes X. A voltage on the scan electrodes Y gradually rises from the positive sustain voltage Vs to the reset voltage Vr by means of the positive ramp waveform PR of the set-up period SU. A dark discharge occurs between the scan electrodes Y and the address electrodes X within all of the discharge cells for the entire screen as well as between the scan electrodes Y and the sustain electrodes Z by means of the positive ramp waveform PR. It will be understood that the term “dark discharge,” as used herein, refers to an equalization of electric potential between two points (e.g., a scan electrode Y and a sustain electrode Z or a scan electrode Y and an address electrode X), where relatively little visible light is generated.

As a result, positive wall charges remain on the address electrodes X and the sustain electrodes Z immediately after the set-up period SU, as shown in FIG. 4b. Negative wall charges also remain on the scan electrode Y. In the set-up period SU, during this dark discharge, a gap voltage Vg between the scan electrodes Y and the sustain electrodes Z and a gap voltage between the scan electrodes Y and the address electrodes X is initialized to a voltage that is, or at least approximates a firing voltage Vf which can generate discharge.

In a set-down period SD of the reset period RP after the set-up period SU, a negative ramp waveform NR is applied to the scan electrodes Y. At the same time, the positive sustain voltage Vs is applied to the sustain electrodes Z, and 0V is applied to the address electrodes X. The voltage on the scan electrodes Y gradually falls from the positive sustain voltage Vs to a negative erase voltage Ve by means of the negative ramp waveform NR. A dark discharge occurs between the scan electrodes Y and the sustain electrodes Z within all of the discharge cells for the entire screen by means of the negative ramp waveform NR simultaneously when a dark discharge is generated between the scan electrodes Y and the address electrodes X. As a result of the set-down period SD, wall charge distribution within each of the discharge cells 1 is changed to a state where addressing is possible, as shown in FIG. 4c. At this time, excessive wall charges unnecessary for the address discharge are erased from the scan electrodes Y and the address electrodes X within each of the discharge cells 1, but a predetermined amount of the wall charges remains thereon. The wall charges on the sustain electrodes Z has its polarity inverted from the positive polarity to the negative polarity as negative wall charges moved from the scan electrodes Y are accumulated. While the dark discharge occurs during the set-down period SD of the reset period RP, the gap voltage between the scan electrodes Y and the sustain electrodes Z and the gap voltage between the scan electrodes Y and the address electrodes X approaches the firing voltage Vf.

In the address period AP, while a negative scan pulse −SCNP is sequentially applied to the scan electrodes Y, a positive data pulse DP is applied to the address electrodes X in synchronism with the scan pulse −SCNP. The voltage of the scan pulse −SCNP is a scan voltage Vsc, which falls from 0V or a negative scan bias voltage Vyb close to 0V to a negative scan voltage −Vy. The voltage of the data pulse DP is a positive data voltage Va. During the address period AP, a positive Z bias voltage Vzb lower than the positive sustain voltage Vs is applied to the sustain electrodes Z. In a state where the gap voltage is adjusted to a voltage close to the firing voltage Vf immediately after the reset period RP, a first address discharge is generated between the scan electrodes Y and the address electrodes X while the gap voltage between the electrodes Y, X exceeds the firing voltage Vf within on-cells to which the scan voltage Vsc and the data voltage Va are applied. In this case, the first address discharge between the scan electrode Y and the address electrode X occurs around an edge which is far from the gap between the scan electrodes Y and the sustain electrodes Z. The first address discharge between the scan electrodes Y and the address electrodes X generates priming charged particles within the discharge cells, and thus causes a second discharge to occur between the scan electrodes Y and the sustain electrodes Z, as shown in FIG. 4d. Wall charge distribution within on-cells where the address discharge is generated is shown in FIG. 4e.

Meanwhile, distribution of wall charges within off-cells where the address discharge is not generated substantially keeps the state of FIG. 4c.

In the sustain period SP, sustain pulses SUSP having a positive sustain voltage Vs are alternately applied to the scan electrodes Y and the sustain electrodes Z. A sustain discharge is thus generated every sustain pulse SUSP between the scan electrodes Y and the sustain electrodes Z within on-cells selected by the address discharge generated with the help of the wall charge distribution as shown in FIG. 4e. On the other hand, a discharge is not generated within off-cells during the sustain period. This is because the gap voltage between the scan electrodes Y and the sustain electrodes Z cannot exceed the firing voltage Vf when the initial positive sustain voltage Vs is applied to the scan electrodes Y since distribution of wall charges for off-cells is kept to the state of FIG. 4c.

However, the conventional plasma display apparatus generates several discharges in order to control the initialization and wall charges of the discharge cells 1 while experiencing the erase period EP of the (n−1)^{th} sub-field SFn−1 and the reset period RP of the n^{th} sub-field SFn. Thus, there are problems in that a dark room contrast value is lowered and the contrast ratio is thus lowered. Table 1 below shows the type and number of discharges generated during the erase period EP of SFₙ₋₁ and the reset period RP of the sub-field SFn in a conventional plasma display apparatus.

TABLE 1

Operating Time

RP of SFn

| Cell State | | EP of SFn-1 | SU | SD |
|---|---|---|---|---|
| On-cells | Opposite | X | O | O |
| turned on in SFn-1 | Discharge (Y-X) | | | |
| | Surface Discharge | O | O | O |
| | (Y-Z) | | | |
| Off-cells | Opposite | X | O | O |
| turned off in SFn-1 | Discharge (Y-X) | | | |
| | Surface Discharge | X | O | O |
| | (Y-Z) | | | |

As can be seen from Table 1, the on-cells that are turned on in the (n−1)^{th} sub-field SFn−1 generate three surface discharges between the scan electrodes Y and the sustain electrodes Z and two opposite discharges between the scan electrodes Y and the address electrodes X during the erase period EP and the reset period RP. Further, the off-cells that are turned off in the entire sub-field SFn generate two surface discharges between the scan electrodes Y and the sustain electrodes Z and two opposite discharges between the scan electrodes Y and the address electrodes X, during the erase period EP and the reset period RP.

Generating several discharges during the erase period and the reset period increases the amount of emission in the erase period and the reset period where the amount of light emission must be minimized in consideration of a contrast characteristic. This causes the dark room contrast value to drop. More particularly, since the amount of light emission in the surface discharge between the scan electrodes Y and the sustain electrodes Z is higher than that of the opposite discharge between the scan electrodes Y and the address electrodes X, the surface discharge has more influence on dark room contrast than the opposite discharge.

Furthermore, in the conventional plasma display apparatus, wall charges are rarely erased in the erase period EP of the (n−1)^{th} sub-field SFn−1. Thus, if wall charges of the negative polarity are excessively accumulated on the scan electrodes Y, there is an insufficient dark discharge during the set-up period SU of the n^{th} sub-field SFn. If the dark discharge is insufficient during the set-up period SU, discharge cells are not initialized. In this case, in order to generate the discharge in the set-up period, the reset voltage Vr has to become higher. If the dark discharge is insufficient during the set-up period SU, the condition within the discharge cell immediately after the reset period fails to result in an optimal address condition. Therefore, abnormal discharge or erroneous discharge will occur. Moreover, if the wall charges of the positive polarity are excessively accumulated on the scan electrodes Y immediately after the erase period EP of the (n−1)^{th} sub-field SFn−1, the discharge is too strong when the positive sustain voltage Vs, which is the start voltage of the positive ramp waveform PR, is applied to the scan electrodes Y in the set-up period SU of the n^{th} sub-field SFn. Initialization is therefore not uniform in each of the cells throughout the entire display. This problem will be described in detail with reference to FIG. 5.

FIG. 5 shows an externally applied voltage Vyz between the scan electrodes Y and the sustain electrodes Z in the set-up period SU and a gap voltage Vg within a discharge cell. At this time, the externally applied voltage Vyz indicated by a solid line in FIG. 5 is an external voltage applied to the scan electrodes Y and the sustain electrodes Z, respectively. Since 0V of the externally applied voltage Vyz is applied to the sustain electrodes Z, it is substantially the same as the voltage of the positive ramp waveform PR. In FIG. 5, dotted lines of \mathring{1}, \mathring{2} and \mathring{3} indicate gap voltages Vg formed in a discharge gas by means of wall charges within a discharge cell. The gap voltages Vg are different, as indicated by the dotted lines of \mathring{1}, \mathring{2} and \mathring{3}, because the amount of wall charges within the discharge cell is different depending upon whether discharge has occurred in the entire sub-fields. The relationship between the externally applied voltage Vyz between the scan electrodes Y and the sustain electrodes Z and the gap voltage Vg formed in the discharge gas within the discharge cell can be expressed into the following Equation 1.
Vyz=Vg+Vw (1)

In FIG. 5, the gap voltage Vg of \mathring{1} illustrates the case where wall charges within a discharge cell are sufficiently erased, and the wall charges are sufficient small. The gap voltage Vg increases in proportion to the externally applied voltage Vyz, but if it reaches the firing voltage Vf, a dark discharge will occur, and the gap voltages within the discharge cells are initialized to the firing voltage Vf.

In FIG. 5, the gap voltage Vg of \mathring{2} illustrates the case where a strong discharge is generated during the erase period EP of the (n−1)^{th} sub-field SF, and the polarity of wall charges is inverted in wall charge distribution within discharge cells. At this time, immediately after the erase period EP, the polarity of wall charges accumulated on the scan electrodes Y is inverted to a positive polarity due to the strong discharge. This occurs when the uniformity of discharge cells is low or the gradient of the erase ramp waveform ERR varies depending upon variation in temperature, if the size of a PDP is large. In this case, since the initial gap voltage Vg excessively increases as illustrated by \mathring{2} of FIG. 5, the gap voltage Vg exceeds the firing voltage Vf simultaneously when the positive sustain voltage Vs is applied to the scan electrodes Y in the set-up period SU. A strong discharge is thus generated. Since discharge cells are not initialized to wall charge distribution reflecting an optimal address condition, i.e., wall charge distribution as shown in FIG. 4c, by means of the strong discharge in the set-up period SU and the set-down period SD, an address discharge can occur in off-cells that have to be turned off. That is, if the discharge during the erase period is strong (i.e., before the reset period), erroneous discharge can occur.

In FIG. 5, the gap voltage Vg of \mathring{3} illustrates the case where distribution of wall charges within a discharge cell remain intact, as a result of a sustain discharge generated just before the erase discharge remains intact because an erase discharge is not generated or is very weak during the erase period EP of the (n−1)^{th} sub-field SF. This will be described in more detail. As shown in FIG. 3, the last sustain discharge is generated when the sustain pulse SUSP is applied to the scan electrodes Y. As a result of this last sustain discharge, wall charges of negative polarity remain on the scan electrodes Y, and wall charges of positive polarity remain on the sustain electrodes Z.

However, although these wall charges must be erased so that initialization is normally performed in a next sub-field, the polarity of the wall charges remains intact if the erase discharge is not generated or the erase discharge is very weak. The reason why the erase discharge is not generated or the erase discharge is very weak is that the uniformity of discharge cells in a PDP is very low or a gradient of the erase ramp waveform ERR varies depending upon variation in temperature. In this case, since the initial gap voltage Vg is very low as the negative polarity as illustrated in \mathring{3} of FIG. 5, the gap voltage Vg within the discharge cells does not reach the firing voltage Vf although the positive ramp waveform PR rises up to the reset voltage Vr in the set-up period. Therefore, the dark discharge is not generated in the set-up period SU and the set-down period SD. Resultantly, if the erase discharge is not generated or the erase discharge is very weak in the erase period before the reset period, erroneous discharge or abnormal discharge occurs since initialization is not performed in a normal manner.

In case of \mathring{2} of FIG. 5, the relationship between the gap voltage Vg and the firing voltage can be expressed into the following Equation 2. In case of \mathring{3} of FIG. 5, the relationship between the gap voltage Vg and the firing voltage can be expressed into the following Equation 3.
Vgini+Vs>Vf (2)
Vgini+Vr<Vf (3)

where Vgini is the initial gap voltage right before the set-up period SU begins, as can be seen from FIG. 5.

In consideration of the above problem, a gap voltage condition (or a wall voltage condition) for enabling initialization to be normally performed in the erase period EP and the reset period RP can be expressed into Equation 4, which satisfies both the equations 2 and 3.
Vf−Vr<Vgini<Vf−Vs (4)

As a result, if the initial gap voltage Vgini does not fulfill the condition of Equation 4 before the set-up period SU, the conventional plasma display apparatus can generate erroneous discharge, miss-discharge or abnormal discharge, and operational margin becomes narrow. In other words, in the conventional plasma display apparatus, the erase operation during the erase period EP has to be performed properly so as to ensure operational reliability and operational margin. However, the normality of the erase operation depends on the uniformity of discharge cells and the temperature of the PDP, as described above.

Further, in the conventional plasma display apparatus, since wall charges accumulated on the scan electrode Y and the sustain electrode Z before the reset period are not sufficient, the set-up discharge is generated around the reset voltage Vr, which is over 100V higher than the sustain voltage Vs. Accordingly, in a conventional plasma display apparatus, an externally applied voltage must be high for the set-up discharge. Resultantly, there is a problem in that the cost for a scan driver circuit increases because a voltage source for generating the high voltage and a high element must be included in the scan driver circuit.

Moreover, in the prior art plasma display apparatus, the address discharge includes the first discharge between the scan electrodes Y and the address electrodes X, and the second discharge using the first discharge between the scan electrodes Y and the sustain electrodes Z, as shown in FIG. 4d. The time necessary to achieve this is relatively long. For this reason, if the conventional plasma display apparatus is being driven by the prior art waveform illustrated in FIG. 3, there is a problem in that the address period is short, possibly to short for higher definition PDPs that employ a greater number of lines. This problem is more pronounced in high-content Xe PDPs having a high jitter value, i.e., a discharge lag value.

### SUMMARY OF THE INVENTION

Accordingly, the present invention has been made in view of the above problems occurring in the prior art, and it is an object of the present invention to provide a plasma display apparatus and method of driving the same, wherein erroneous discharge, miss-discharge and abnormal discharge are prevented, dark room contrast is increased, and operational margin is improved.

Another object of the present invention is to provide a plasma display apparatus and method of driving the same, wherein the set-up discharge is lowered.

Still another object of the present invention is to provide a plasma display apparatus and method of driving the same, wherein the time necessary for an address discharge is shortened.

To achieve the above objects, according to an aspect of the present invention, there is provided a plasma display apparatus including surface discharge electrode pairs having a first electrode and a second electrode, a third electrode that intersects the surface discharge electrode pairs, and a plurality of discharge cells disposed at the intersections of the surface discharge electrode pairs and the third electrode, the plasma display apparatus further comprising a first driving unit for applying a first waveform to the first electrode during a pre-reset period prior to a reset period, applying a first ramp waveform having an opposite polarity direction to that of the first waveform to the first electrode in the reset period, and then applying a second ramp waveform having an opposite polarity direction to that of the first ramp waveform to the first electrode; and a second driving unit for applying a second waveform having an opposite polarity direction to that of the first waveform to the second electrode during the pre-reset period, and applying a third ramp waveform having the same polarity direction as that of the second ramp waveform to the second electrode in synchronization with the second ramp waveform during the reset period.

### BRIEF DESCRIPTION OF THE DRAWINGS

Further objects and advantages of the invention can be more fully understood from the following detailed description taken in conjunction with the accompanying drawings in which:

FIG. 1 shows a sub-field pattern of an 8-bit default code for implementing 256 gray scales in a plasma display apparatus;

FIG. 2 is a schematic showing the arrangements of electrodes in a three-electrode AC surface discharge type PDP in accordance with the prior art;

FIG. 3 shows a driving waveform for a common PDP;

FIGS. 4a to 4e illustrates the distribution of wall charges within a discharge cell, step by step, which change depending upon the driving waveform shown in FIG. 3;

FIG. 5 shows the variation of an externally applied voltage, between a scan electrode and a sustain electrode, and a gap voltage within a discharge cell during a set-up period when a PDP is driven according to the driving waveform shown in FIG. 3;

FIG. 6 shows a driving waveform in a first sub-field period for driving a PDP according to a first embodiment of the present invention;

FIGS. 7a to 7e illustrates the distribution of wall charges within a discharge cell, step by step, which vary depending upon the driving waveform shown in FIG. 6;

FIG. 8 is a driving waveform in the remaining sub-field periods other than the first sub-field period which is used in the method of driving the plasma display apparatus according to a first embodiment of the present invention;

FIG. 9 shows the distribution of wall charges which are formed within a discharge cell immediately after a sustain period by means of the driving waveform shown in FIG. 8;

FIG. 10 shows the distribution of wall charges within a discharge cell formed before a set-up period by means of the driving waveform of FIGS. 6 and 8, and a gap voltage;

FIG. 11 shows the variation in an externally applied voltage between a scan electrode and a sustain electrode and a gap voltage within a discharge cell in a set-up period when the plasma display apparatus is driven according to the driving waveform shown in FIGS. 6 and 8;

FIG. 12 illustrates the variation in the polarity of wall charges on a sustain electrode during an erase period and a reset period, caused by the conventional driving waveform shown in FIG. 3;

FIG. 13 illustrates the variation in the polarity of wall charges on a sustain electrode during a reset period, caused by the driving waveform as shown in FIGS. 6 and 8;

FIG. 14 shows a waveform for driving a plasma display apparatus according to a second embodiment of the present invention;

FIG. 15 illustrates a driving waveform of a first sub-field for driving a plasma display apparatus according to a third embodiment of the present invention;

FIG. 16 shows a driving waveform of the remaining sub-field periods other than the first sub-field period for driving the plasma display apparatus according to a third embodiment of the present invention;

FIG. 17 shows a driving waveform of an entire frame period to which the driving waveforms of FIGS. 15 and 16 are applied;

FIG. 18 shows a waveform for driving a plasma display apparatus according to a fourth embodiment of the present invention;

FIG. 19 shows a waveform for driving a plasma display apparatus according to a fifth embodiment of the present invention;

FIG. 20 shows a driving waveform in a first sub-field period for driving a plasma display apparatus according to a sixth embodiment of the present invention;

FIG. 21 shows a driving waveform in the remaining sub-field periods other than the first sub-field period for driving the plasma display apparatus according to a sixth embodiment of the present invention;

FIG. 22 shows a driving waveform in a first sub-field period for driving a plasma display apparatus according to a seventh embodiment of the present invention;

FIG. 23 shows a driving waveform in the remaining sub-field periods other than the first sub-field period for driving the plasma display apparatus according to a seventh embodiment of the present invention;

FIG. 24 shows a driving waveform in a first sub-field period for driving a plasma display apparatus according to an eighth embodiment of the present invention;

FIG. 25 shows a driving waveform in the remaining sub-field periods other than the first sub-field period for driving the plasma display apparatus according to an eighth embodiment of the present invention;

FIG. 26 shows a waveform for driving a plasma display apparatus according to a ninth embodiment of the present invention;

FIG. 27 illustrates a portion of a driving waveform applied during sub-fields other than the first sub-field for driving the plasma display apparatus according to a ninth embodiment of the present invention;

FIGS. 28a to 28d illustrate the distribution of wall charges within a discharge cell, step by step, which vary depending upon the driving waveform shown in FIG. 27;

FIG. 29 is a waveform illustrating a difference in an external voltage, applied between a scan electrode and a sustain electrode, and a discharge cell gap voltage between the scan electrode and the sustain electrode in the driving waveform shown in FIG. 27;

FIG. 30 is a waveform illustrating a difference in an external voltage, applied between a scan electrode and a sustain electrode, and a discharge cell gap voltage between the scan electrode and the sustain electrode in the driving waveform shown in FIG. 26;

FIG. 31 is a waveform illustrating a driving waveform applied during sub-fields of one frame period for a plasma display apparatus according to a tenth embodiment of the present invention; and

FIG. 32 is a block diagram illustrating the configuration of a plasma display apparatus according to an embodiment of the present invention.

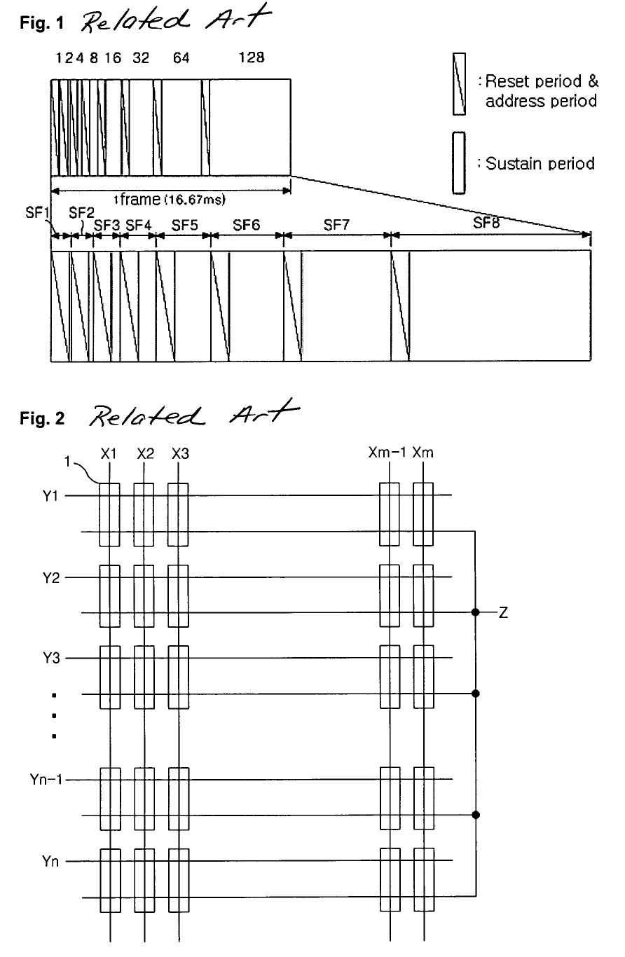

### DETAILED DESCRIPTION OF THE PREFERRED EMBODIMENT

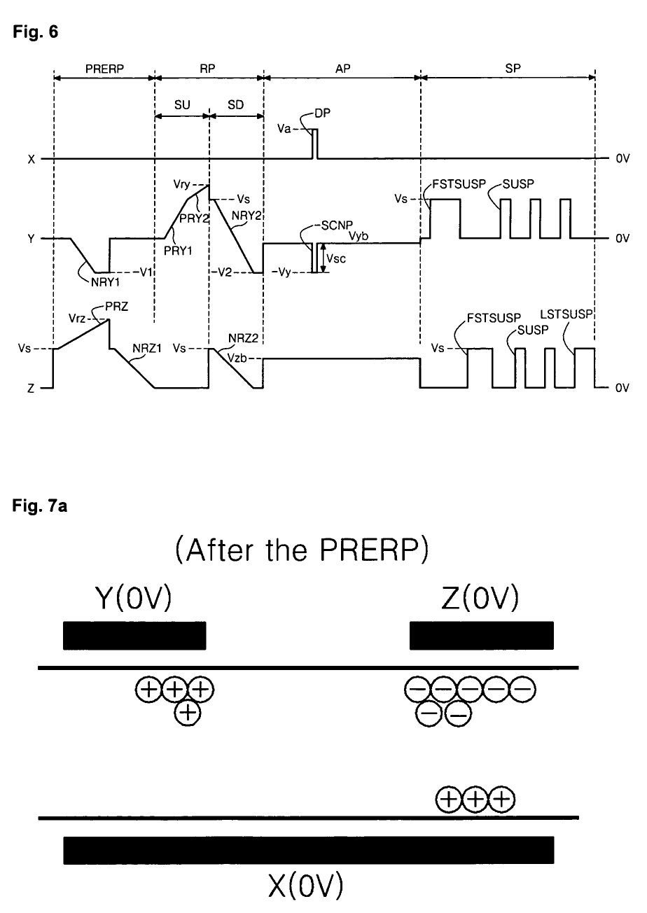

The present invention will now be described in detail in connection with preferred embodiments and with reference to FIGS. 6 to 32.

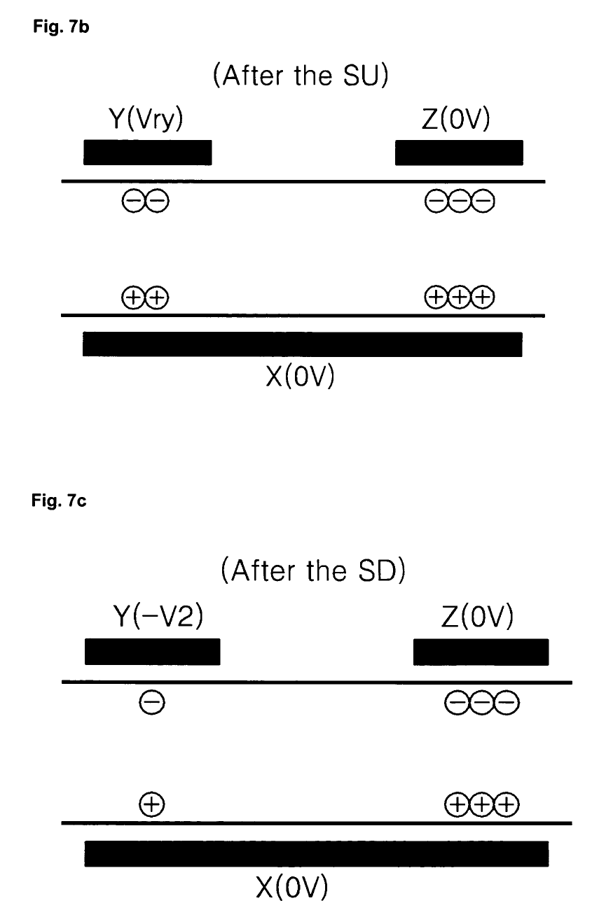

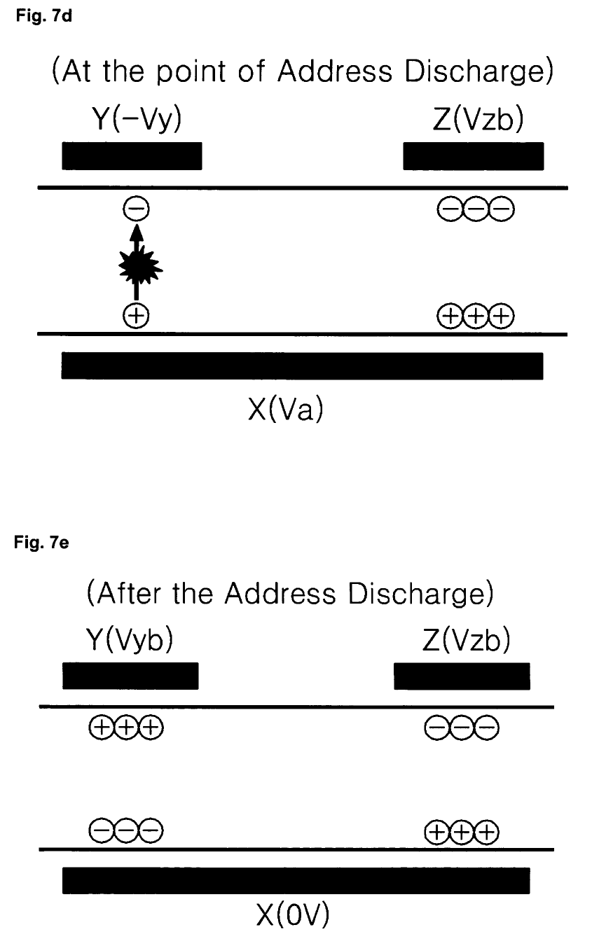

FIG. 6 shows a driving waveform supplied to the PDP shown in FIG. 2 during a first sub-field period, for driving a PDP according to a first embodiment of the present invention. The driving waveform of FIG. 6 will be described in conjunction with the distribution of wall charges shown in FIGS. 7a to 7e.

Referring to FIG. 6, in one method of driving the PDP according to the present invention, a first sub-field includes a pre-reset period PRERP for forming wall charges of the positive polarity on the scan electrodes Y and wall charges of the negative polarity on the sustain electrodes Z, a reset period for initializing discharge cells of the entire screen using wall charge distribution established during the pre-reset period PRERP, an address period AP for selecting discharge cells, and a sustain period SP for sustaining discharging of selected discharge cells. In the present embodiment, as shown in FIG. 7a, positive electric charges at the scan electrodes sufficiently accumulate by means of surface discharge during the pre-reset period between the scan electrodes and the sustain electrodes.

In the pre-reset period PRERP, a Z positive ramp waveform PRZ whose voltage rises from a positive sustain voltage Vs up to a positive Z reset voltage Vrz is applied to all the sustain electrodes Z. A first Y negative ramp waveform NRY1 whose voltage drops from 0V or a reference voltage GND to a negative voltage of −V1 is also applied to all the scan electrodes Y. While the voltage of the sustain electrodes Z is raised by the positive ramp waveform PRZ, the voltage of the scan electrodes Y is lowered by the first Y negative ramp waveform NRY1, and the voltage V1 is then kept for a predetermined time. During the pre-reset period PRERP, 0V is applied to the address electrodes X. The Z positive ramp waveform PRZ and the first Y negative ramp waveform NRY1 cause a dark discharge to occur between the scan electrodes Y and the sustain electrodes Z and between the sustain electrodes Z and the address electrodes X in all of the discharge cells. As a result, immediately after the pre-reset period PRERP, wall charges of the positive polarity are accumulated on the scan electrodes Y and a large amount of wall charges of the negative polarity is accumulated on the sustain electrodes Z, in all the discharge cells, as shown in FIG. 7a. Furthermore, positive wall charges are accumulated on the address electrodes X. A sufficiently high positive gap voltage is formed in the internal discharge gas spaces of all the discharge cells between the scan electrodes Y and the sustain electrodes Z by means of the wall charge distribution shown in FIG. 7a. An electric field is also formed within each of the discharge cells from the scan electrodes Y toward the sustain electrodes Z. In such a pre-reset period, the ramp waveforms applied to the scan electrodes and/or the sustain electrodes are supplied during at least one sub-field of a frame. Preferably, the ramp waveforms applied to the scan electrodes and/or the sustain electrodes during the pre-reset period are supplied during the first sub-field the frame. This is because it is more difficult to initialize the cells during the first sub-field. That is, since space charges within the cells during the first sub-field are smaller than those in other sub-fields, initialization is difficult. More particularly, such a phenomenon is more profound when the temperature within a panel is relatively high. Accordingly, it is preferable that the ramp waveforms be applied to the scan electrodes and/or the sustain electrodes during the pre-reset period when the temperature is greater than a critical temperature, e.g., of 40° C. or more. Furthermore, the wall charges are enhanced in such a way that the voltage associated with the sustain electrodes Z gradually drops to 0V or the reference voltage GND by means of the first Z negative ramp waveform NRZ1, and the difference between the voltage of the scan electrodes Y and the voltage of the sustain electrodes Z in the set-up period becomes great. This leads to a reduction in erroneous discharge at high temperature.

In a set-up period SU of the reset period RP, a first Y positive ramp waveform PRY1 and a second Y positive ramp waveform PRY2 are consecutively applied to all the scan electrodes Y, and 0V is applied to the sustain electrodes Z and the address electrodes X. The voltage of the first Y positive ramp waveform PRY1 rises from 0V up to a positive sustain voltage Vs, and the voltage of the second Y positive ramp waveform PRY2 rises up to a positive Y reset voltage Vry, which is higher than the positive sustain voltage Vs. The positive Y reset voltage Vry is lower than a positive Z reset voltage Vrz, and is decided as a voltage between the positive Z reset voltage Vrz and the positive sustain voltage Vs. Furthermore, the slope of the first Y positive ramp waveform PRY1 and the slope of the second Y positive ramp waveform PRY2 can be set so they are the same. It is, however, preferred that the slope of the second Y positive ramp waveform PRY2 is less than the slope of the first Y positive ramp waveform PRY1, as shown in FIG. 6. The reason why the slope of the second Y positive ramp waveform PRY2 is preferably lower than the slope of the first Y positive ramp waveform PRY1 is for preventing strong discharge from occurring during the set-up period of the reset period. That is, if the slope of the second Y positive ramp waveform PRY2 is greater than the slope of the first Y positive ramp waveform PRY1, a strong discharge will degrade the contrast characteristic. Due to both the first Y positive ramp waveform PRY1 and the voltage of the electric field formed between the scan electrodes Y and the sustain electrodes Z within the discharge cell, a dark discharge occurs between the scan electrodes Y and the sustain electrodes Z and between the scan electrodes Y and the address electrodes X in the entire discharge cells. As a result of this discharge, immediately after the set-up period SU, as wall charges of a negative polarity are accumulated on the scan electrodes Y within all of the discharge cells, as shown in FIG. 7b, the polarity of the wall charges changes from a positive polarity to a negative polarity. Thus, more wall charges of the positive polarity are accumulated on the address electrodes X. Furthermore, the wall charges that have accumulated on the sustain electrodes Z are partially reduced in amount as the wall charges of a negative polarity are reduced toward the scan electrodes Y, but nevertheless remain negative.

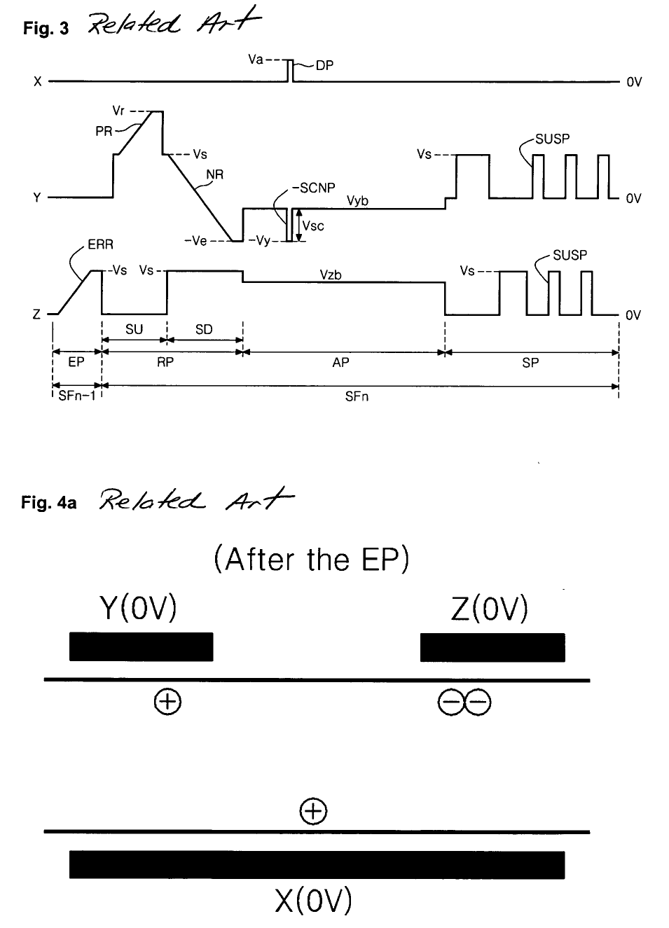

Meanwhile, before the dark discharge occurs during the set-up period SU, which is caused by the wall charge distribution right after the pre-reset period PRERP, the positive gap voltage is sufficiently high within all of the discharge cells. Thus, the Y reset voltage Vr can be lower than the conventional reset voltage Vr as shown in FIG. 3. According to an experiment where the wall charge distribution in all of the discharge cells immediately before the set-up discharge is initialized as shown in FIG. 7a, it was found that the set-up discharge occurs at a lower voltage than the sustain voltage Vs in all of the discharge cells, i.e., the discharge associated with the first Y positive ramp waveform PRY1 is weak. For this reason, in the driving waveform of FIG. 6, the second Y positive ramp waveform PRY2 may be unnecessary. The voltage applied to the scan electrodes Y during the set-up period SU can also stably generate the set-up discharge although it is raised only up to the sustain voltage Vs by means of the first Y positive ramp waveform PRY1.

The wall charges of the positive polarity are sufficiently accumulated on the address electrodes X through the pre-reset period PRERP and the set-up period SU. An externally applied voltage necessary upon address discharge, i.e., an absolute value of the data voltage and the scan voltage can be thus lowered.

In a set-down period SD of the reset period RP after the set-up period SU, a second Z negative ramp waveform NRZ2 is applied to the sustain electrodes Z, while a second Y negative ramp waveform NRY2 is applied to the scan electrodes Y. The voltage of the second Y negative ramp waveform NRY2 drops from the positive sustain voltage Vs to a negative voltage of −V2. The voltage of the second Z negative ramp waveform NRZ2 drops from the positive sustain voltage Vs to 0V or a reference voltage. The voltage −V2 can be set to the same value as, or a different value than the voltage −V1 of the pre-reset period PRERP. During the set-down period SD, a discharge does not occur between the scan electrodes Y and the sustain electrodes Z because the voltages therebetween are equally lowered, whereas a dark discharge does occur between the scan electrodes Y and the address electrodes X. The dark discharge causes the excessive wall charges of a negative polarity which have accumulated on the scan electrodes Y to be erased, and the excessive wall charges of a positive polarity which have accumulated on the address electrodes X to be erased. Resultantly, all of the discharge cells now have a uniform wall charge distribution, as shown in FIG. 7c. The wall charge distribution of FIG. 7c raises the gap voltage between the scan electrodes Y and the address electrodes X almost up to the firing voltage Vf because wall charges of a negative polarity are sufficiently accumulated on the scan electrodes Y, and wall charges of a positive polarity are sufficiently accumulated on the address electrodes X. Accordingly, the wall charge distribution for all of the discharge cells is adjusted to an optimal address condition immediately after the set-down period SD.

In the address period AP, while a negative scan pulse −SCNP is sequentially applied to the scan electrodes Y, a positive data pulse DP is applied to the address electrodes X in synchronism with the scan pulse −SCNP. The voltage of the negative scan pulse −SCNP is Vsc, which drops from 0V or a negative scan bias voltage Vyb around 0V to a negative scan voltage −Vy. The voltage of the positive data pulse DP is Va. During the address period AP, a positive Z bias voltage Vzb lower than the positive sustain voltage Vs is applied to the sustain electrodes Z. Preferably, the positive Z bias voltage Vzb is applied between the end of the set-down period of the reset period and the application time of the first scan pulse to the scan electrodes Y. The reason why the positive Z bias voltage Vzb is applied at the end of the set-down period of the reset period is that a voltage difference between the scan electrodes Y and the positive Z in the set-down period of the reset period is reduced to prohibit discharge that may otherwise occur, thereby improving image contrast. Further, the reason why the positive Z bias voltage Vzb is applied at the time of the first scan pulse to the scan electrodes Y is that an address discharge occurring in the address period is not influenced. Where the gap voltage for all of the discharge cells is adjusted to an optimal address condition immediately after the reset period RP, an address discharge is generated only between the scan electrodes Y and the address electrodes X within on-cells to which the scan voltage Vsc and the data voltage Va are applied as the gap voltage between the electrodes Y, X exceeds the firing voltage Vf. Wall charge distribution within the on-cells where the address discharge is generated is shown in FIG. 7d. Immediately after the address discharge is generated, the wall charge distribution within the on-cells is changed, as shown in FIG. 7e, by means of the address discharge as wall charges of a positive polarity are accumulated on the scan electrodes Y and wall charges of a negative polarity are accumulated the address electrodes X.

The address discharge is generated only between the scan electrode Y and the address electrode X, as shown in FIG. 7d. The time necessary for the address discharge is thus significantly reduced.

Meanwhile, off-cells in which 0V or a reference voltage is applied to the address electrodes X and/or 0V or the scan bias voltage Vyb is applied to the scan electrodes Y, the gap voltage is less than the firing voltage. Accordingly, in the off-cells where the address discharge is not generated, wall charge distribution keeps the state of FIG. 7c.

In the sustain period SP, sustain pulses FIRSTSUSP, SUSP and LSTSUSP exhibiting a positive sustain voltage Vs are alternately applied to the scan electrodes Y and the sustain electrodes Z. During the sustain period SP, 0V or a reference voltage is applied to the address electrodes X. The sustain pulse FSTSUSP, which is first applied to each of the scan electrodes Y and the sustain electrodes Z, has its pulse width that is wider than the normal sustain pulse SUSP so that the start of the sustain discharge can be stabilized. Further, the last sustain pulse LSTSUSP is applied to the sustain electrodes Z. In an initial state of the set-up period SU, the pulse width of LSTSUSP is set wider than the normal sustain pulse SUSP so that wall charges of a negative polarity can sufficiently accumulate on the sustain electrodes Z. During the sustain period, in on-cells selected by the address discharge, a sustain discharge is generated between the scan electrodes Y and the sustain electrodes Z for every sustain pulse SUSP with the help of the wall charge distribution shown in FIG. 7e. On the contrary, in off-cells, since the initial wall charge distribution of the sustain period SP is the same as that of FIG. 7c, the gap voltage is kept less than the firing voltage Vf eventhough the sustain pulses FIRSTSUSP, SUSP and LSTSUSP are applied. Thus, discharge does not occur.

Again, the driving waveform illustrated in FIG. 6 is not limited to only the first sub-field, but can be applied one or more sub-fields including the first sub-field. It can also be applied to all of the sub-fields included in a frame period.

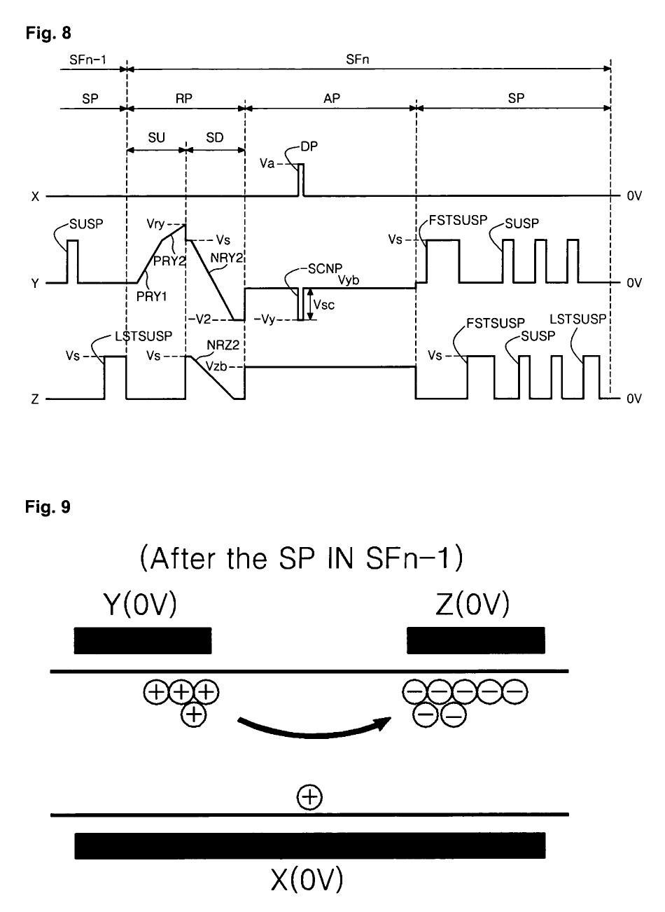

FIG. 8 shows a driving waveform, which is applied to a PDP as shown in FIG. 2 during the sustain period SP of the (n−1)^{th} (where, n is a positive integer greater than 2) sub-field SFn and the n^{th} sub-field SFn, which is used in a method of driving the plasma display apparatus according to the first embodiment of the present invention. The driving waveform of FIG. 8 will be described in conjunction with wall charge distribution of FIG. 9.

Referring to FIG. 8, the n^{th} sub-field SFn initializes all of the discharge cells of the PDP using a wall charge distribution formed immediately after the sustain period in the (n−1)^{th} sub-field SFn−1.

Both the (n−1)^{th} sub-field SFn−1 and the n^{th} sub-field SFn include a reset period RP, for initializing all of the discharge cells with the help of wall charge distribution where wall charges of a negative polarity sufficiently accumulate on the sustain electrodes Z, an address period AP for selecting discharge cells and a sustain period SP for sustaining the discharging of selected discharge cells.

During the sustain period SP of the (n−1)^{th} sub-field SFn−1, the last sustain pulse SUSP is applied to the sustain electrodes Z. At this time, 0V or a reference voltage is applied to the scan electrodes Y and the address electrodes X. The last sustain pulse LSTSUSP causes a last sustain discharge to occur between the scan electrodes Y and the sustain electrodes Z within discharge cells, and also causes wall charges of a positive polarity to sufficiently accumulate on the scan electrodes Y and wall charges of a negative polarity to sufficiently accumulate on the sustain electrodes Z, as shown in FIG. 9.

In a set-up period SU of the n^{th} sub-field SFn, a dark discharge occurs in all of the discharge cells using the wall charge distribution of FIG. 9, so that the wall charge distribution for all discharge cells is initialized to a wall charge distribution as shown in FIG. 7b. The set-up period SU, and set-down initialization, and address and sustain operations are substantially the same as those of the first sub-field of FIG. 6. Thus, detailed description thereof will be omitted.

In the plasma display apparatus and method of driving the same according to the present invention, the set-up period of a next sub-field comes immediately after the last sustain discharge for these sub-fields, without the erase period for erasing wall charges between the sustain period of the sub-field and the reset period of a next sub-field, as described above.

The sustain discharge is a strong glow discharge. Thus, a sufficiently large amount of wall charges is accumulated on the scan electrodes Y and the sustain electrodes Z. Further, the positive polarity of the wall charges on the scan electrodes Y and the negative polarity of the wall charges on the sustain electrodes Z can be stably maintained.

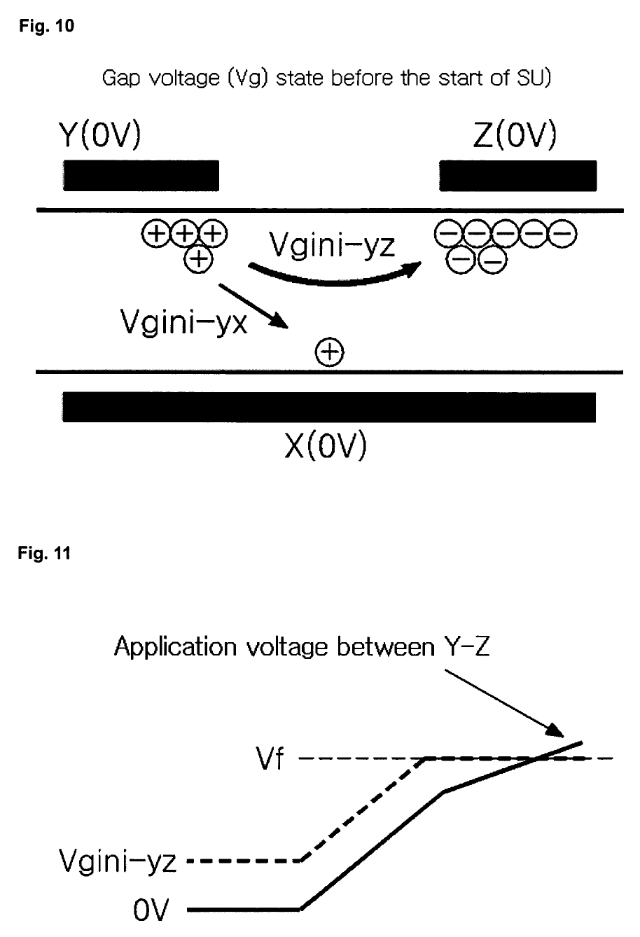

FIG. 10 shows a gap voltage state of a discharge cell, which is formed by the last sustain discharge or a discharge of the pre-reset period PRERP.

Referring to FIG. 10, a discharge is generated between the scan electrode Y and the sustain electrode Z by means of the last sustain pulse LSTSUSP or waveforms NRY1, PRZ and NRZ1 of the pre-reset period PRERP. Thus, immediately before the set-up period SU, an inter Y−Z initial gap voltage Vgini−yz, which is directed from the scan electrodes Y to the sustain electrodes Z, is formed, and an inter Y−X initial gap voltage Vgini−yx, which is directed from the scan electrode Y to the address electrode X, is formed by electric field, within the discharge cell.

As shown in FIG. 10, before the set-up period SU, the inter Y−Z initial gap voltage Vgini−yz is already formed in the discharge cell by the wall charge distribution as shown in FIG. 10. Thus, if a voltage greater than or equal to the difference between the firing voltage Vf and the inter Y−Z initial gap voltage Vgini−yz is applied externally, a dark discharge is generated within the discharge cell during the set-up period SU. This can be expressed by the following Equation (5).
Vyz≧Vf−Vgini−yz (5)

where Vyz is an external voltage which is applied to the scan electrodes Y and the sustain electrodes Z during the set-up period SU (hereinafter, referred to as the “inter Y−Z external voltage”). With respect to the waveforms illustrated in FIGS. 6 and 8, the inter Y−Z external voltage corresponds to the voltage of the positive ramp waveforms PRY1, PRY2 applied to the scan electrodes Y and 0V applied to the sustain electrodes Z.

As can be seen from Equation (5) and FIG. 11, if the inter Y−Z external voltage Vyz is sufficiently high, such that it is greater than or equal to the difference between the firing voltage Vf and the inter Y−Z initial gap voltage Vgini−yz during the set-up period SU, a dark discharge can be stably generated within a surface discharge cell as wide driving margin.

In a plasma display apparatus according to an embodiment of the present invention, the amount of light emission, which is generated during the reset period of each sub-field, is very small compared to the prior art. This is because the number of discharges generated within a discharge cell during the reset period of each sub-field is smaller than that of the prior art, and the number of surface discharges is small.

Table 2 shows the type and number of discharges generated during the pre-reset period PRERP of the first sub-field and the reset period RP as described by the waveform of FIG. 6. Table 3 shows the type and number of discharges generated during the reset period RP of each of the remaining sub-fields without a pre-reset period PRERP as described by the waveform of FIG. 8.

TABLE 2

Operating Time

RP

| Cell State | PRERP | SU | SD |
|---|---|---|---|
| Opposite Discharge (Y-X) | O | O | O |
| Surface Discharge (Y-Z) | O | O | X |

TABLE 3

| | | Operating Time | |
|---|---|---|---|
| | | RP of SFn | |
| Cell State | | SU | SD |
| On-cells turned on | Opposite Discharge (Y-X) | O | X |
| in SFn-1 | Surface Discharge (Y-Z) | O | O |
| Off-cells turned | Opposite Discharge (Y-X) | X | O |
| off in SFn-1 | Surface Discharge (Y-Z) | X | X |

As can be seen from Table 2, in the first sub-field, employing a waveform as shown in FIG. 6, a maximum of three opposite discharges and two surface discharges are generated through the pre-reset period PRERP and the reset period RP. Thereafter, in the next sub-fields, during the reset period RP, one opposite discharge and a maximum of two surface discharges are generated, as shown in Table 3. In case of off-cells that are turned off during the entire sub-fields, only one opposite discharge is generated. In a plasma display apparatus according to the present invention, if one frame period is driven with it being time-divided into 12 sub-fields, the brightness level of a dark screen is lowered by ⅓ compared to a conventional plasma display apparatus due to the difference in the number and type of discharges that are generated. Accordingly, the plasma display apparatus according to the present invention can display a dark screen with a dark room contrast value that is lower than that of the prior art, and can thus display an image more brightly.

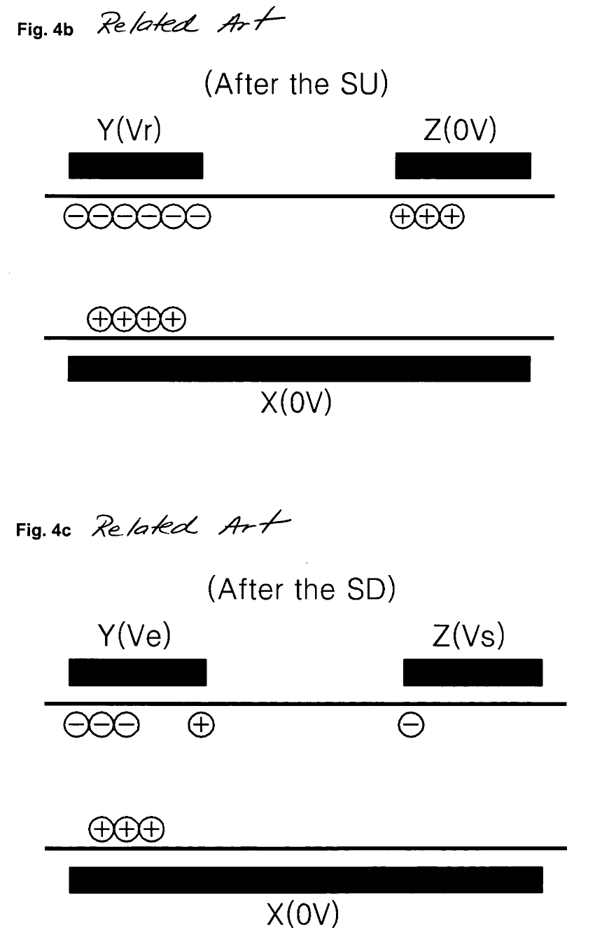

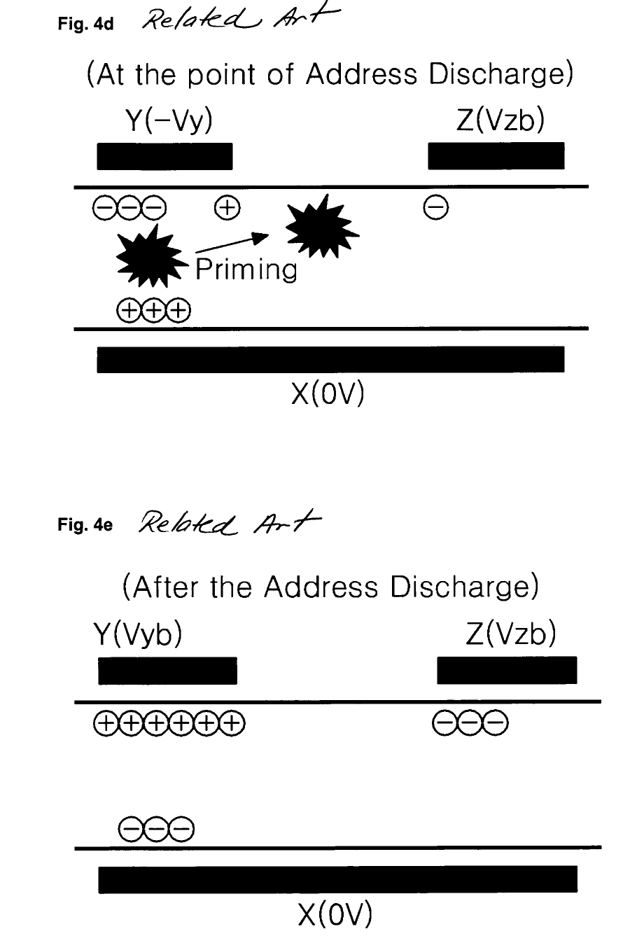

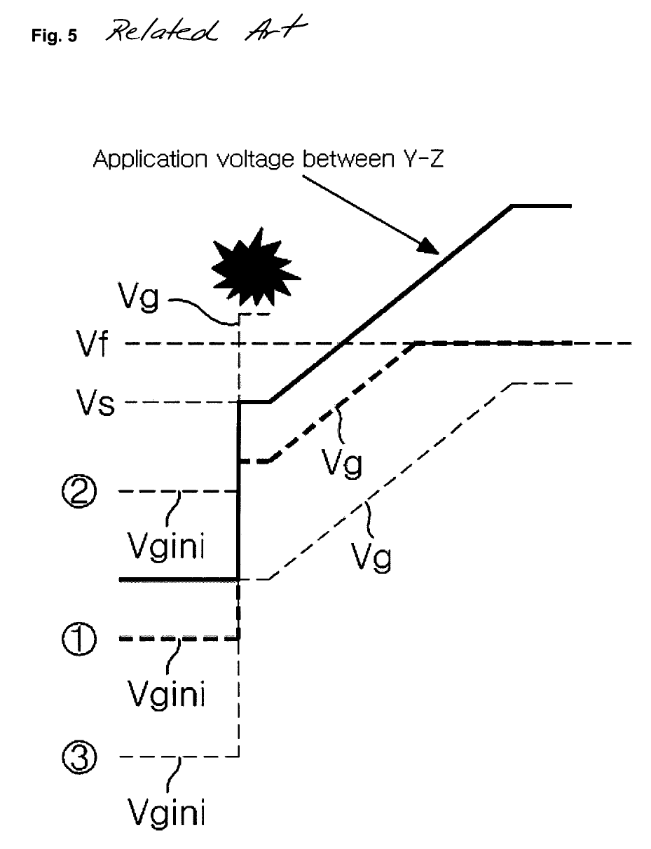

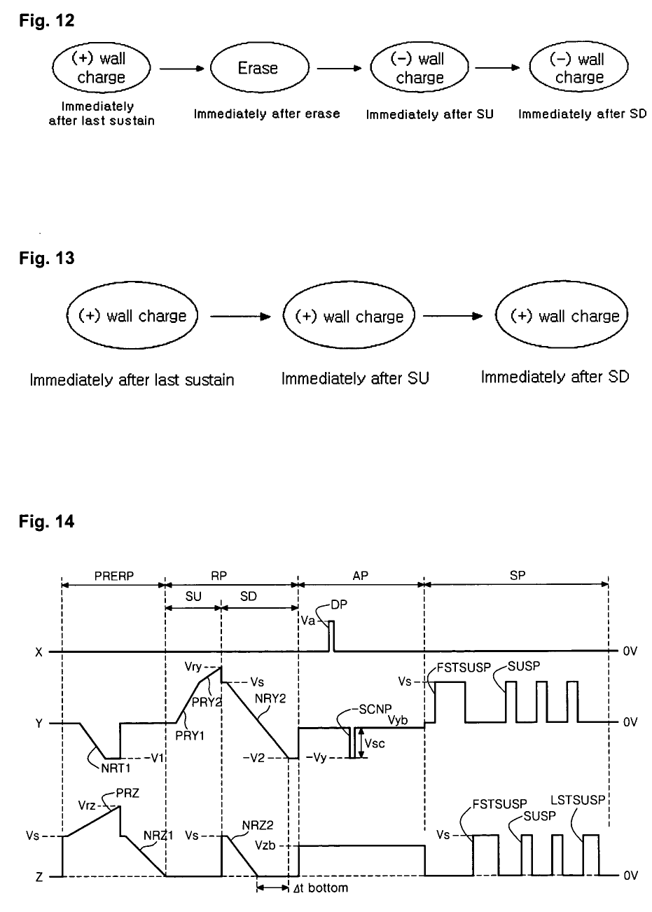

The small number of discharges generated during the reset period RP means that the variation in wall charges or the polarity within discharge cells is small. For example, in a conventional plasma display apparatus, the polarity of the wall charges on the sustain electrodes Z, from immediately after the last sustain discharge of the (n−1)^{th} sub-field SFn−1 until immediately after the dark discharge of the set-down period SD of the n^{th} sub-field SFn, changes from a positive polarity to an erase state (FIG. 4a) to a positive polarity (FIG. 4b) to a negative polarity (FIG. 4c), as shown in FIG. 12. On the other hand, in the plasma display apparatus according to the present invention, the polarity of the wall charges on the sustain electrodes Z, from immediately after the last sustain discharge of the (n−1)^{th} sub-field SFn−1 until immediately after the dark discharge of the set-down period SD of the n^{th} sub-field SFn, maintains a negative polarity, as shown in FIG. 13. That is, in the plasma display apparatus according to the present invention, the polarity of the wall charges on the sustain electrodes Z is maintained as shown in FIGS. 7a, 7b and 7c in the initialization process, prior to the address period AP.

FIG. 14 shows a waveform for explaining a method of driving a plasma display apparatus according to a second embodiment of the present invention.

FIG. 14 illustrates a waveform for use in a method of driving the plasma display apparatus according to a second embodiment of the present invention. In this embodiment, the second Z negative ramp waveform NRZ2 reaches the reference voltage GND before the second Y negative ramp waveform NRY2 reaches the reference voltage GND.

In the present embodiment, the pre-reset period PRERP, the set-up period SU of the reset period RP, the address period AP and the sustain period SP are substantially the same as those of the aforementioned embodiment. A detailed description thereof will be thus omitted for simplicity.

During the set-down period SD of the reset period RP, the second Z negative ramp waveform NRZ2 is applied to the sustain electrodes Z simultaneously when the second Y negative ramp waveform NRY2 is applied to the scan electrodes Y. The voltage of the second Y negative ramp waveform NRY2 falls from the positive sustain voltage Vs to the negative voltage of −V2. The voltage of the second Z negative ramp waveform NRZ2 falls from the positive sustain voltage Vs to 0V or the reference voltage GND. After a predetermined time delay (At bottom) following the point in time that the second Z negative ramp waveform NRZ2 reached the reference voltage GND, the second Y negative ramp waveform NRY2 reaches the reference voltage GND. As such, if the voltage of the second Y negative ramp waveform NRY2 reaches the reference voltage GND while the voltage of the second Z negative ramp waveform NRZ2 is maintained at the reference voltage, variation in the voltage of the scan electrode Y can be prevented and the voltage −V2 can be held constant, due to coupling of the scan electrodes Y and the sustain electrodes Z. Thus, there is an advantage in that driving margin can be stably secured. During the set-down period SD, a dark discharge is generated between the scan electrodes Y and the address electrodes X. The dark discharge causes excessive wall charges of a negative polarity, which have accumulated on the scan electrodes Y, to be erased and excessive wall charges of a positive polarity, which have accumulated on the address electrodes X, to be erased. As a result, all of the discharge cells have a uniform wall charge distribution that is optimal for addressing.

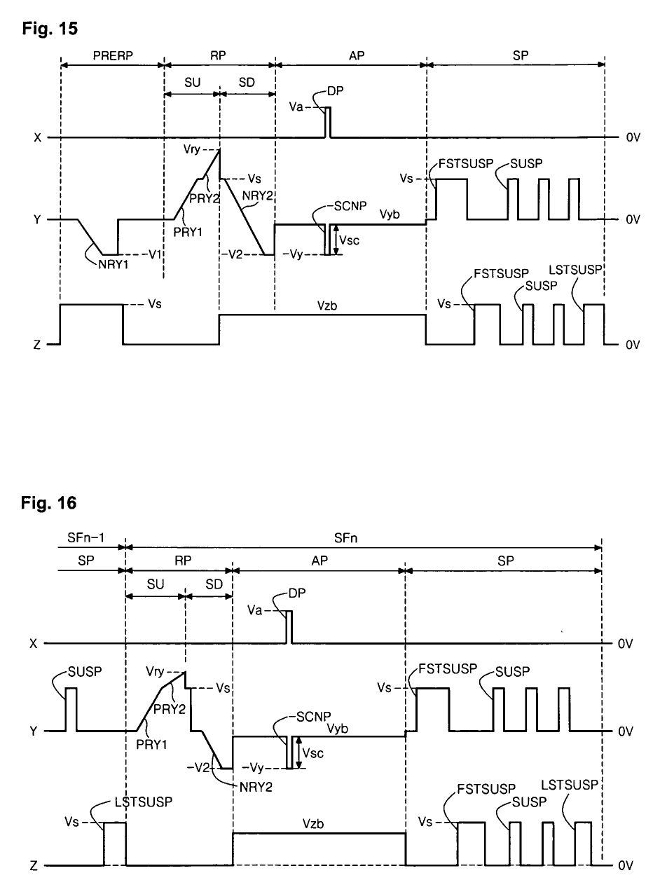

FIG. 15 shows a driving waveform of a first sub-field in a method of driving a plasma display apparatus according to a third embodiment of the present invention. As shown, during a pre-reset period PRERP, a ramp waveform is not supplied to sustain electrodes Z, instead, a sustain voltage in the form of a square type wave is supplied to the sustain electrodes Z, so that negative wall charges accumulate on the sustain electrodes Z. During a set-down period SD, a square type wave is supplied to the sustain electrodes Z, so that the sustain electrodes Z are maintained at a positive bias voltage. It will be understood that a square type wave is one in which the voltage changes from approximately 10 percent to 90 percent of its maximum value over a time period that is generally less than 10 μs, remains substantially level for a second period of time, and then changes from 90 percent to 10 percent of its maximum value over yet a third period of time that is, once again, generally less than 10 μs.

In the pre-reset period PRERP, the positive sustain voltage Vs is applied to all the sustain electrodes Z before a first Y negative ramp waveform NRY1 is applied to the scan electrodes Y. That is, a first Y negative ramp waveform NRY1 is applied to the scan electrodes Y during the period where the square, sustain voltage waveform is applied to the sustain electrodes Z. This is for preventing the generation of noise, which may occur due to an interaction between the square type wave and the first Y negative ramp waveform NRY1 by applying the first Y negative ramp waveform NRY1 during the period where the square type wave is applied. It should be noted that, in the alternative, a square type wave could be applied to the scan electrodes Y, while applying a ramp waveform of opposite polarity to the sustain electrodes Z.

The first Y negative ramp waveform NRY1 is a waveform in which the voltage drops from 0V, or the reference voltage GND, to a negative voltage of −V1 for the scan electrodes Y. The negative voltage of −V1 may be greater than the negative voltage level for −V2 of a second Y negative ramp waveform NRY2 that will be applied to the scan electrodes Y, which will be described later. Preferably, however the negative voltage −V1 can be set to the same voltage level as the negative voltage level −V2 of the second Y negative ramp waveform NRY2. In this later case, there is a cost savings since the voltage source used in achieving the voltage level of the first Y negative ramp waveform NRY1 and the second Y negative ramp waveform NRY2 can be the same voltage source. Further, the voltage level of the square type wave applied to the sustain electrodes Z is greater than a scan bias voltage vyb to be described later.

During the pre-reset period PRERP, 0V is applied to the address electrodes X. The positive sustain voltage Vs applied to the sustain electrode Z and the first Y negative ramp waveform NRY1 applied to the scan electrode Y cause a dark discharge to occur between the scan electrodes Y and the sustain electrodes Z and between the sustain electrodes Z and the address electrodes X in all of the discharge cells. As a result of this discharge, all of the discharge cells are initialized such that they have a wall charge distribution as shown in FIG. 7a immediately after the pre-reset period PRERP.

In the set-up period SU of the reset period RP, a first Y positive ramp waveform PRY1 and a second Y positive ramp waveform PRY2 are sequentially applied to all the scan electrodes Y, while 0V are applied to the sustain electrodes Z and the address electrodes X. The voltage of the first Y positive ramp waveform PRY1 rises from 0V to a positive sustain voltage Vs, and the voltage of the second Y positive ramp waveform PRY2 rises from the positive sustain voltage Vs to a positive Y reset voltage Vry. The slope of the first waveform PRY1 and the slope of the second Y positive ramp waveform PRY2 are the same. While the first Y positive ramp waveform PRY1 and a voltage of the electric field formed between the scan electrodes Y and the sustain electrodes Z within the discharge cell are added, a dark discharge is generated between the scan electrodes Y and the sustain electrodes Z and between the scan electrodes Y and the address electrodes X in all of the discharge cells. As a result of these discharges, wall charges having a distribution as shown in FIG. 7b accumulate on all of the discharge cells immediately after the set-up period SU.

In the set-down period SD of the reset period RP, the second Y negative ramp waveform NRY2 is applied to the scan electrodes Y, and the square type wave of the Z bias voltage Vzb is applied to the sustain electrodes Z. The voltage of the second Y negative ramp waveform NRY2 drops from the positive sustain voltage Vs to a negative voltage −V2. During the set-down period SD, a dark discharge is concentrically generated between the scan electrodes Y and the sustain electrodes Z with the help of wall charges accumulated on the discharge cells during the pre-reset period PRERP. As a result of the dark discharge, the discharge cells are initialized so that they have a distribution of the wall charges as shown in FIG. 7c.

In the address period AP, while a negative scan pulse −SCNP is sequentially applied to the scan electrodes Y, a positive data pulse DP is applied to the address electrodes X in synchronism with the scan pulse −SCNP. During the address period AP, a positive Z bias voltage Vzb lower than the positive sustain voltage Vs is applied to the sustain electrodes Z.

Where the gap voltage for all of the discharge cells is optimally adjusted for addressing, immediately after the reset period RP, an address discharge is generated only between the scan electrodes Y and the address electrodes X within on-cells to which the scan voltage Vsc and the data voltage Va are applied as the gap voltage between the electrodes Y, X exceeds the firing voltage Vf. Wall charge distribution within the on-cells where the address discharge is generated is the same as shown in FIG. 7d. Immediately after the address discharge is generated, the wall charge distribution within the on-cells is changed as shown in FIG. 7e by means of the address discharge as the wall charges of a positive polarity accumulate on the scan electrodes Y and the wall charges of a negative polarity accumulate on the address electrodes X.

The sustain period SP is substantially the same as that of the aforementioned embodiments. Thus, a description thereof will be omitted.

FIG. 16 is a waveform for use in a method of driving a plasma display apparatus according to the third embodiment of the present invention. More specifically, FIG. 16 illustrates a driving waveform applied during the remaining sub-fields Sfₙ₋₁ (where, n is a positive integer greater than 2).

Referring to FIG. 16, in the method of driving the plasma display apparatus according to the present invention, an additional pre-reset period PRERP is not allocated. During the set-down period SD, a voltage that drops from 0V or the reference voltage GND is applied to the scan electrodes Y, and the voltage on the sustain electrodes Z is maintained at 0V or the reference voltage GND. Furthermore, an erase discharge is not generated between a sustain period of the (n−1)^{th} sub-field and the reset period RP of the n^{th} sub-field.

In each of the sub-fields SFn2 to SFn, during the set-down period SD of the reset period RP, a second Y negative ramp waveform NRY2 is applied to the scan electrodes Y, and the reference voltage GND or 0V is applied to the sustain electrodes Z and the address electrodes X. The set-up period SU, the address period AP, and the sustain period SP are substantially the same as those of FIG. 8. Thus, a detailed description thereof will be omitted in order to avoid redundancy. A reset voltage Vry in the set-up period SU is set to a voltage that is lower than that of the first sub-field because lots of wall charges are accumulated within the discharge cells compared to the first sub-field.

The voltage of the second Y negative ramp waveform NRY2 falls from 0V or the reference voltage GND to a negative voltage −V2 unlike the above-described embodiments in order to reduce the set-down period. During the set-down period SD, a dark discharge is generated between the scan electrodes Y and the address electrodes X with the help of the wall charges on the address electrodes X, which have accumulated due to the sustain discharge of the entire sub-field. The dark discharge causes excessive wall charges of a negative polarity, which have accumulated on the scan electrodes Y, to be erased, and excessive wall charges of a positive polarity, which have accumulated on the address electrodes X, to be erased.

If the voltage of the second Y negative ramp waveform NRY2 falls from 0V or the reference voltage, the set-down period SD becomes short compared to the aforementioned embodiments. Further, although the voltage of the second Y negative ramp waveform NRY2 becomes lower than 0V or the reference voltage, the voltage difference between the scan electrodes Y and the sustain electrodes Z is small. In the plasma display apparatus of the present embodiment, initialization is further stabilized while more effectively prohibiting discharge between the scan electrodes Y and the sustain electrodes Z. Therefore, according to the present embodiment, more driving time is available and the initialization operation of the set-down period SD can be more stably performed, due to the reduction in the set-down period SD.

The sustain driving circuits, in accordance with the embodiments of FIGS. 15 and 16, do not apply a ramp waveform to the sustain electrodes Z. Thus, the sustain driving circuits can be easily implemented by controlling only timing, (i.e., because voltage level remains constant) while using an existing sustain electrode driving circuit. Accordingly, the sustain driving circuit according to the present embodiment can be obtained or implemented for less cost.

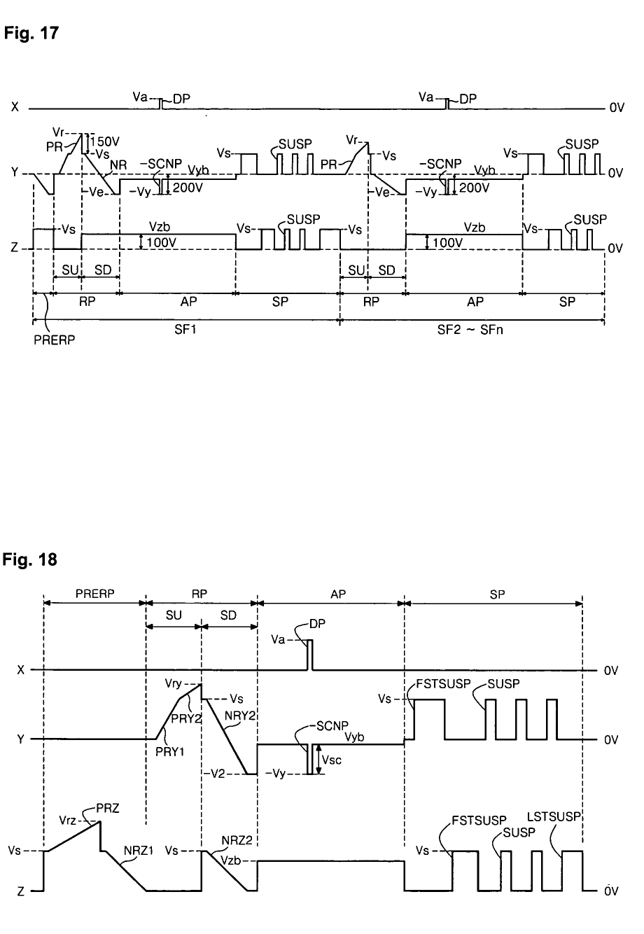

Meanwhile, in order to use the wall charges on the address electrode X, which are accumulated by the sustain discharge of the entire sub-field, there is no erase discharge between a sustain period of a last sub-field of a previous frame and a pre-reset period PREPR of a first sub-field of a current frame. No erase discharge exists between the sustain period SP of the first sub-field and the set-up period SU of next sub-fields. FIG. 17 shows an example in which the driving waveforms of FIGS. 15 and 16 are applied to a driving waveform during one frame period.

FIG. 18 shows a waveform for use in a method of driving a plasma display apparatus according to a fourth embodiment of the present invention.

Referring to FIG. 18, during a pre-reset period PRERP, a ramp waveform is applied to only the sustain electrodes Z.

In the present embodiment, a reset period RP, an address period AP and a sustain period SP are substantially the same as those of FIG. 6. Thus, a detailed description on them will be omitted for simplicity.

In the pre-reset period PRERP, a Z positive ramp waveform PRZ whose voltage rises from a positive sustain voltage Vs to a positive Z reset voltage Vrz is applied to all the sustain electrodes Z. During this period, 0V or the reference voltage GND is also applied to the scan electrodes Y and the address electrodes X. The Z positive ramp waveform PRZ causes a dark discharge to occur between the scan electrodes Y and the sustain electrodes Z and between the sustain electrodes Z and the address electrodes X in all of the discharge cells. As a result, immediately after the pre-reset period PRERP, wall charges of a positive polarity are accumulated on the scan electrodes Y and a large amount of wall charges of a negative polarity are accumulated on the sustain electrodes Z, in all of the discharge cells. Wall charges of a positive polarity are also accumulated on the address electrodes X. The discharges during the pre-reset period PRERP and the effect thereof are similar to those of the embodiment of FIG. 6. Accordingly, the present embodiment is advantageous in that a scan electrode driving circuit can be easily controlled because the ramp waveform is applied to only the sustain electrodes Z, while still achieving the discharge effect of the pre-reset period PRERP, when compared with the embodiment of FIG. 6.

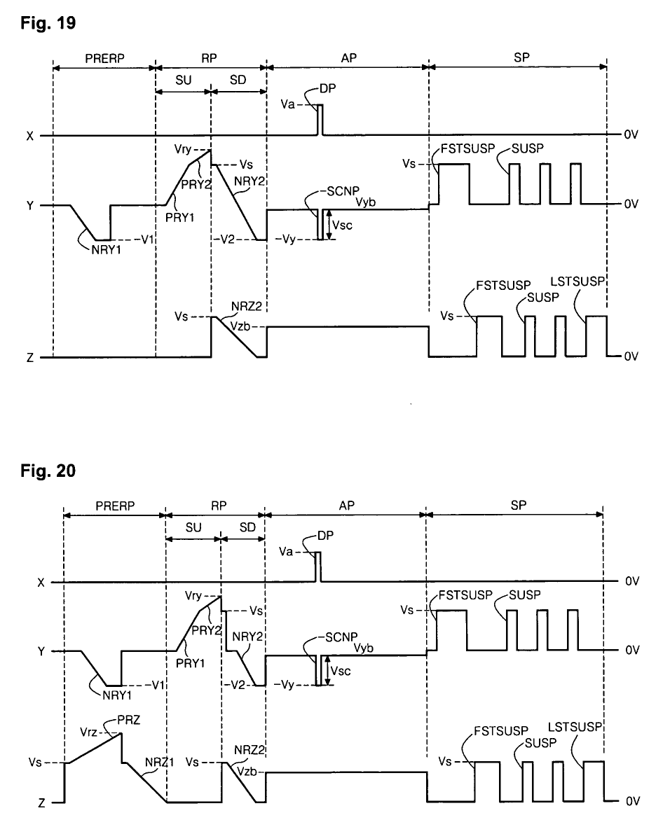

FIG. 19 shows a waveform for use in a method of driving a plasma display apparatus according to a fifth embodiment of the present invention. Referring to FIG. 19, during a pre-reset period PRERP, a ramp waveform is applied to only the scan electrodes Y.

In the present embodiment, a reset period RP, an address period AP and a sustain period SP are substantially the same as those of the embodiment of FIG. 6. A detailed description thereof will be thus omitted for simplicity.

In the pre-reset period PRERP, a first Y negative ramp waveform NRY1 whose voltage falls from 0V or a reference voltage GND to a negative voltage of −V1 is applied to all the scan electrodes Y. During this period, 0V or the reference voltage GND is also applied to the sustain electrodes Z and the address electrodes X. The first Y negative ramp waveform NRY1 causes a dark discharge to occur between the scan electrodes Y and the sustain electrodes Z and between the sustain electrodes Z and the address electrodes X in all of the discharge cells. As a result, immediately after the pre-reset period PRERP, wall charges of a positive polarity are accumulated on the scan electrodes Y and wall charges of a negative polarity are accumulated on the sustain electrodes Z for all of the discharge cells. Wall charges of a positive polarity are also accumulated on the address electrodes X. The discharges during the pre-reset period RERP and the effect thereof are similar to those of the embodiment of FIG. 6. Accordingly, the present embodiment is advantageous in that a scan electrode driving circuit can be easily controlled because the ramp waveform is applied to only the scan electrodes Y, while still achieving the discharge effect of the pre-reset period PRERP, when compared with the embodiment of FIG. 6.

The driving waveforms of FIGS. 18 and 19 are not limited to only the first sub-field, but can be applied to several sub-fields including the first sub-field and the remaining sub-fields included in a frame period, in the same manner as the embodiment of FIG. 6. Further, in the same manner as FIG. 8, the pre-reset period PRERP in the remaining sub-fields can be omitted.

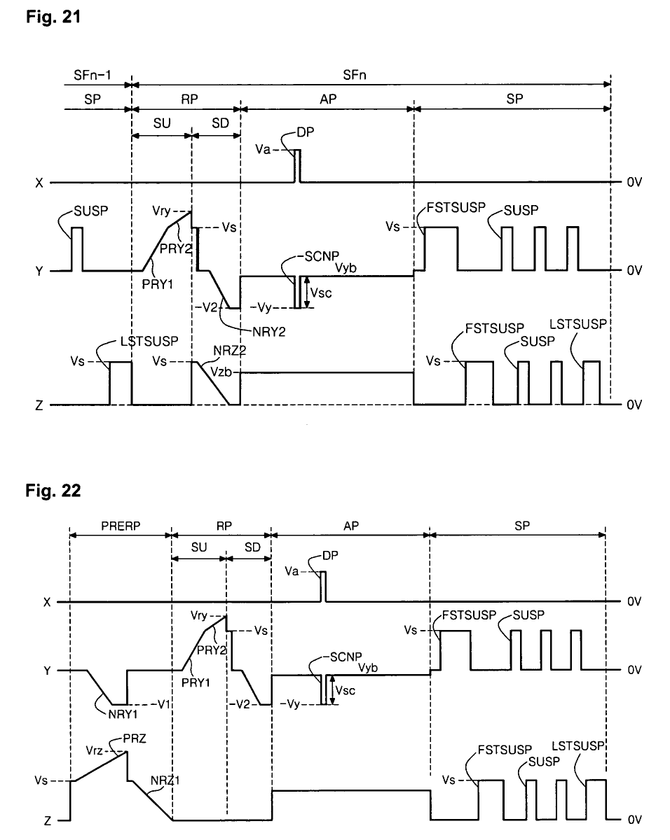

FIG. 20 shows a driving waveform in a first sub-field period for use in a method of driving a plasma display apparatus according to a sixth embodiment of the present invention. FIG. 21 shows a driving waveform for a sustain period SP in an (n−1)^{th} (where, n is a positive integer greater than 2) sub-field SFₙ₋₁ and an n^{th} sub-field SFn according to the sixth embodiment of the present invention.

Referring to FIGS. 20 and 21, in the method of driving the plasma display apparatus according to the present invention, for each of the sub-fields, a voltage, which falls from 0V or the reference voltage GND, is applied to the scan electrodes Y during a set-down period SD, so that wall charge distribution for all of the discharge cells, which are initialized during a set-up period SU, is made uniform.

The first sub-field includes a pre-reset period PRERP, a reset period RP, an address period AP and a sustain period SP, as shown in FIG. 20, and the remaining sub-fields SFn includes a reset period RP, an address period AP and an sustain period SP, as shown in FIG. 21. That is, in the sub-fields other than the first sub-field, the pre-reset period PREPR can be omitted.

The operation during each of the pre-reset period PRERP, the set-up period SU, the address period AP and the sustain period SP is substantially the same as that of the above-described embodiments. Thus, a detailed description thereof will be omitted.

In each of the sub-fields SFn−1, SFn, during a set-down period SD of the reset period RP, while a second Y negative ramp waveform NRY2 is applied to the scan electrodes Y, a second Z negative ramp waveform NRZ2 is applied to the sustain electrodes Z. The voltage of the second Y negative ramp waveform NRY2 falls from 0V or a reference voltage GND to a negative voltage of −V2 unlike the aforementioned embodiments. The voltage of the second Z negative ramp waveform NRZ2 falls from the positive sustain voltage Vs to 0V or the reference voltage. Since the voltages of the scan electrodes Y and the sustain electrodes Z are lowered at the same time during the set-down period SD, a discharge is not generated between them. On the contrary, a dark discharge is generated between the scan electrodes Y and the address electrodes X. The dark discharge causes excessive wall charges of a negative polarity, which have accumulated on the scan electrodes Y, to be erased, and excessive wall charges of a positive polarity, which have accumulated on the address electrodes X, to be erased.

If the voltage of the second Y negative ramp waveform NRY2 falls from 0V or the reference voltage, the set-down period SD is short compared to the above-described embodiments. Further, the voltage difference between the scan electrodes Y and the sustain electrodes Z is small although the voltage of the second Y negative ramp waveform NRY2 is lowered from 0V or the reference voltage. Therefore, in the plasma display apparatus of the present embodiment, initialization can be performed more stably, while more effectively prohibiting the discharge between the scan electrodes Y and the sustain electrodes Z. Thus, according to the present embodiment, more much driving time is available and the initialization operation of the set-down period SD can be performed more stably due to the reduction in the set-down period SD.

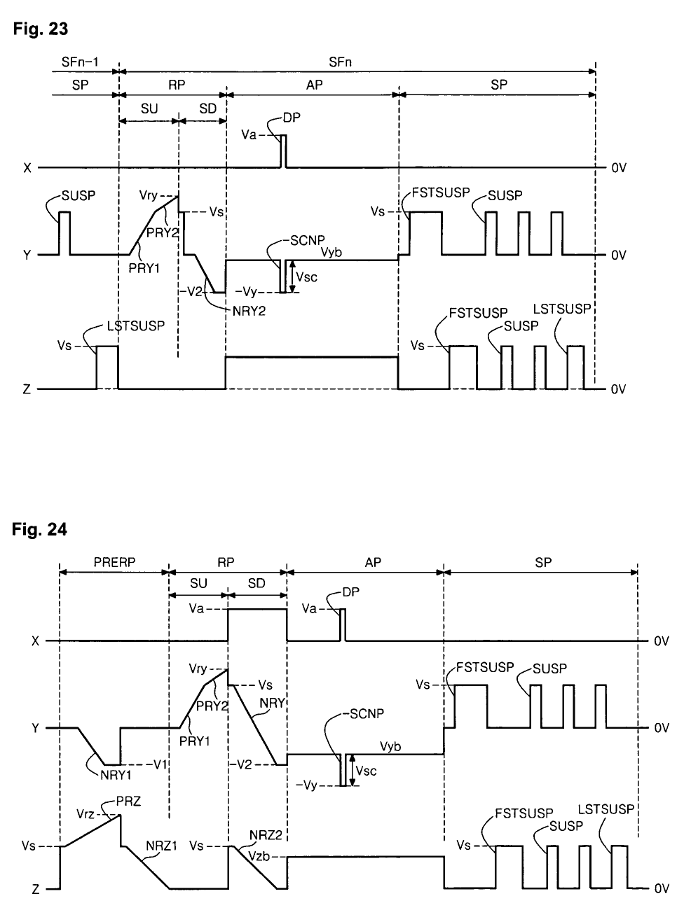

FIG. 22 shows a driving waveform in a first sub-field period for use in a method of driving a plasma display apparatus according to a seventh embodiment of the present invention. FIG. 23 shows a driving waveform for a sustain period SP of an (n−1)^{th} sub-field SFₙ₋₁ and an n^{th} sub-field SFn according to the seventh embodiment of the present invention.

Referring to FIGS. 22 and 23, in the method of driving the plasma display apparatus according to the present invention, during a set-down period SD, for each of the sub-fields, a voltage that falls from 0V or a reference voltage GND is applied to the scan electrodes Y, while the voltage on the sustain electrodes Z is maintained at 0V or the reference voltage GND. The wall charge distribution for all of the discharge cells, which is initialized in the set-up period SU, thus becomes uniform.

A first sub-field includes a pre-reset period PRERP, a reset period RP, an address period AP and a sustain period SP, as shown in FIG. 22, and the remaining sub-fields SFn include a reset period RP, an address period AP and a sustain period SP, as shown in FIG. 23. That is, in the sub-fields other than the first sub-field, the pre-reset period PRERP can be omitted.

The operation during each of the pre-reset period PRERP, the set-up period SU, the address period AP and the sustain period SP is the same as that of FIGS. 20 and 21. Thus, a detailed description thereof will be omitted.

Referring to FIGS. 22 and 23, in the method of driving the plasma display apparatus according to the present invention, the voltage of the sustain electrodes Z is maintained at 0V or the reference voltage GND, while the voltage that is applied to the scan electrodes Y during the set-down period SD drops from 0V or the reference voltage GND. There is no erase discharge during the sustain period of the n−1^{th} (where, n is 2 or more) sub-field nor the pre-reset period PRERP of the n^{th} sub-field.

In each of the sub-fields SFn−1, SFn, during the set-down period SD of the reset period RP, a second Y negative ramp waveform NRY2 is applied to the scan electrodes Y. During this period, 0V or the reference voltage GND is also applied to the sustain electrodes Z and the address electrodes X. The voltage of the second Y negative ramp waveform NRY2 falls from 0V or the reference voltage GND to a negative voltage of −V2. In sub-fields after the second sub-field, a dark discharge is generated between the scan electrodes Y and the address electrodes X with the help of wall charges on the address electrodes X, which are accumulated due to the sustain discharges of previous sub-fields during the set-down period SD. The dark discharge causes excessive negative wall charges, which are accumulated on the scan electrodes Y, to be erased, and excessive positive wall charges, which are accumulated on the address electrodes X to be deleted. In the first sub-field, during the set-down period SD, a dark discharge is generated between the scan electrodes and the address electrodes with the help of wall charges on the address electrodes X, which are accumulated during the pre-reset period PRERP. The dark discharge causes excessive negative wall charges on the scan electrodes to be erased, and excessive positive wall charges on the address electrodes to be erased.

If the voltage of the second Y negative ramp waveform NRY2 drops from 0V or the reference voltage, the set-down period SD shortens as compared with some of the above-described embodiments. Further, the voltage difference between the scan electrodes Y and the sustain electrodes Z is small although the voltage of the second Y negative ramp waveform NRY2 is lowered from 0V or the reference voltage. Therefore, in the plasma display apparatus of the present embodiment, initialization is more stable while more effectively prohibiting the discharge between the scan electrodes Y and the sustain electrodes Z. Furthermore, when compared with the embodiments of FIGS. 20 and 21, the present embodiment is advantageous in that the sustain electrode driving circuit can be more easily controlled since the ramp waveform is applied to only the scan electrodes Y during the set-down period SD. Thus, according to the present embodiment, more much driving time is available due to the reduction in the set-down period SD and the sustain electrode driving circuit can be more easily controlled.

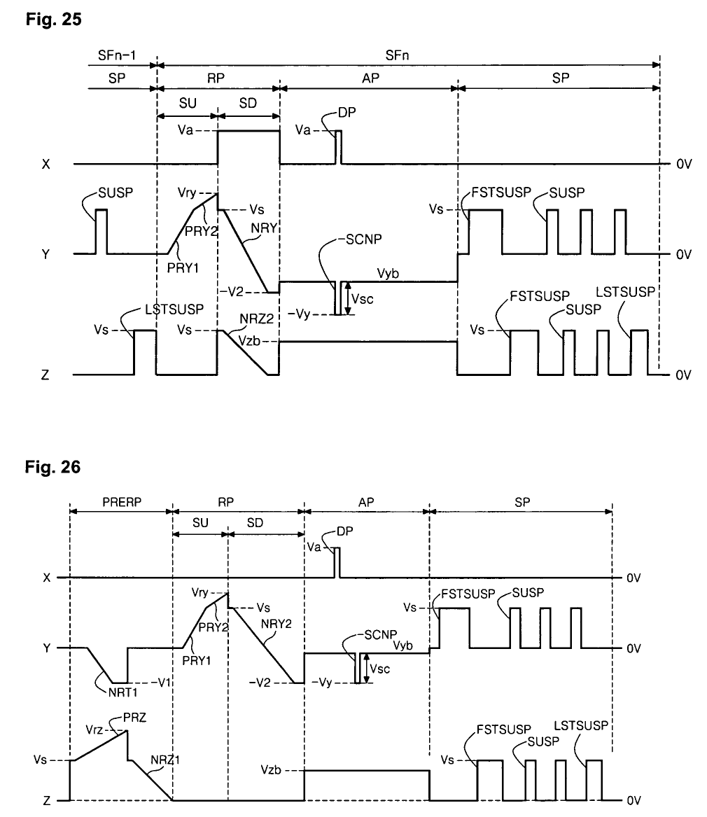

FIG. 24 shows a driving waveform in a first sub-field period for use in a method of driving a plasma display apparatus according to an eighth embodiment of the present invention. FIG. 25 shows a driving waveform during a sustain period SP of an (n−1)^{th} sub-field SFₙ₋₁ and an n^{th} sub-field SFn in the method of driving the plasma display apparatus according to an eighth embodiment of the present invention.

Referring to FIGS. 24 and 25, in the method of driving the plasma display apparatus according to the present invention, during a set-down period SD, a positive bias voltage is applied to the address electrodes during the set-down SD period of each sub-field.

The first sub-field includes a pre-reset period PRERP, a reset period RP, an address period AP and a sustain period SP, as shown in FIG. 24, and the remaining sub-fields SFn include a reset period RP, an address period AP and a sustain period SP, as shown in FIG. 25. That is, in sub-fields other than the first sub-field, the pre-reset period PRERP can be omitted.

The operations of the pre-reset period PRERP, the set-up period SU, the address period AP and the sustain period SP are substantially the same as those described above with respect to the embodiment of FIG. 6. A detailed description thereof will be thus omitted for simplicity.

In each of the sub-fields SFn−1, SFn, during the set-down period SD of the reset period RP, while a second Y negative ramp waveform NRY2 is applied to the scan electrodes Y, a second Z negative ramp waveform NRZ2 is applied to the sustain electrodes Z. The voltage of the second Y negative ramp waveform NRY2 drops from a positive sustain voltage Vs to a negative voltage −V2. Alternatively, the voltage of the second Y negative ramp waveform NRY2 can drop from 0V or the reference voltage, as in the embodiments of FIGS. 20 to 23. Meanwhile, the voltage of the second Z negative ramp waveform NRZ2 drops from the positive sustain voltage Vs to 0V or the reference voltage. During this period, a bias voltage of a positive polarity is also applied to the address electrodes X. For example, the bias voltage may be the same voltage as the data voltage Va Since the voltages of the scan electrodes Y and the sustain electrodes Z are lowered at the same time, a discharge is not generated between them. On the contrary, a dark discharge is generated between the scan electrodes Y and the address electrodes X. The positive polarity, bias voltage at the address electrodes X increases the voltage difference between the address electrodes X and the scan electrodes Y, thus causing the dark discharge to occur more rapidly during the set-up period SD. It also lengthens the time that the dark discharge is generated. Thus, even when the deviation in the discharge characteristics between respective discharge cells is severe, the bias voltage causes the dark discharge to occur once in each discharge cell, thereby further increasing the uniformity of wall charge distribution in all of the discharge cells.

Again, the driving waveforms illustrated in FIGS. 20, 22 and 24 are not limited to the first sub-field, but can be applied to one or more sub-fields including the first sub-field. It can be also applied to all of the sub-fields in a frame.

FIG. 26 shows a waveform for use in a method of driving a plasma display apparatus according to a ninth embodiment of the present invention. Referring to FIG. 26, during a reset period RP, the voltage of the sustain electrodes Z is maintained at a reference voltage.

In the present embodiment, the pre-reset period PRERP, the set-up period SU of the reset period RP, the address period AP and the sustain period SP are the same as the aforementioned embodiments. A detailed description thereof will thus be omitted.

During the set-down period SD of the reset period RP, a second Y negative ramp waveform NRY2 is applied to the scan electrodes Y, and a reference voltage GND is applied to the sustain electrodes Z. During this period, a dark discharge is generated between the scan electrodes Y and the address electrodes X. The dark discharge causes excessive wall charges of a negative polarity, which have been accumulated on the scan electrodes Y, to be erased, and excessive wall charges of a positive polarity, which have been accumulated on the address electrodes X, to be erased. Resultantly, all of the discharge cells have a uniform wall charge distribution, which is optimal for purposes of addressing.

In the present embodiment, the dark discharge generated during the set-down period SD is induced only between the scan electrodes Y and the address electrodes X. As a result, an address discharge is generated only between the scan electrodes Y and the address electrodes X by means of the wall charge distribution within the discharge cell. For this reason, the time necessary for addressing is short. A detailed description thereof will be made in conjunction with FIGS. 26 to 29.

In FIGS. 6, 7, 18 to 26, the positive Z bias voltage Vzb applied to the sustain electrodes Z during the address period AP is lower than the sustain voltage Vs and the scan voltage Vsc so that the address discharge can occur between the scan electrodes Y and the address electrodes X.

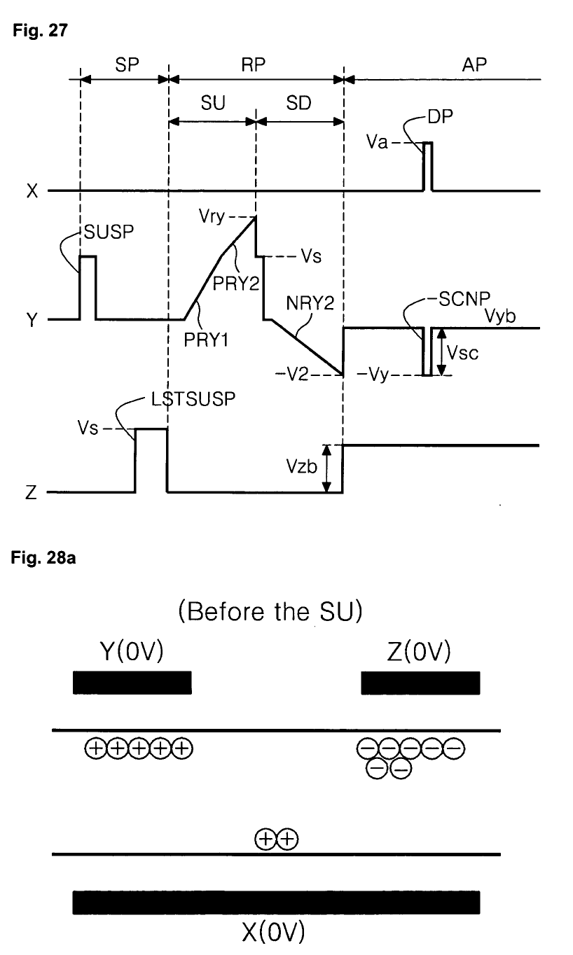

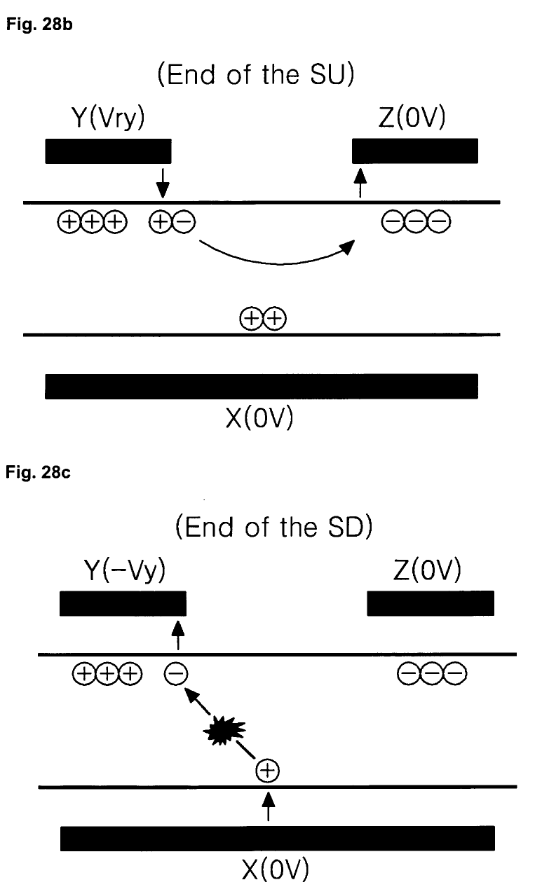

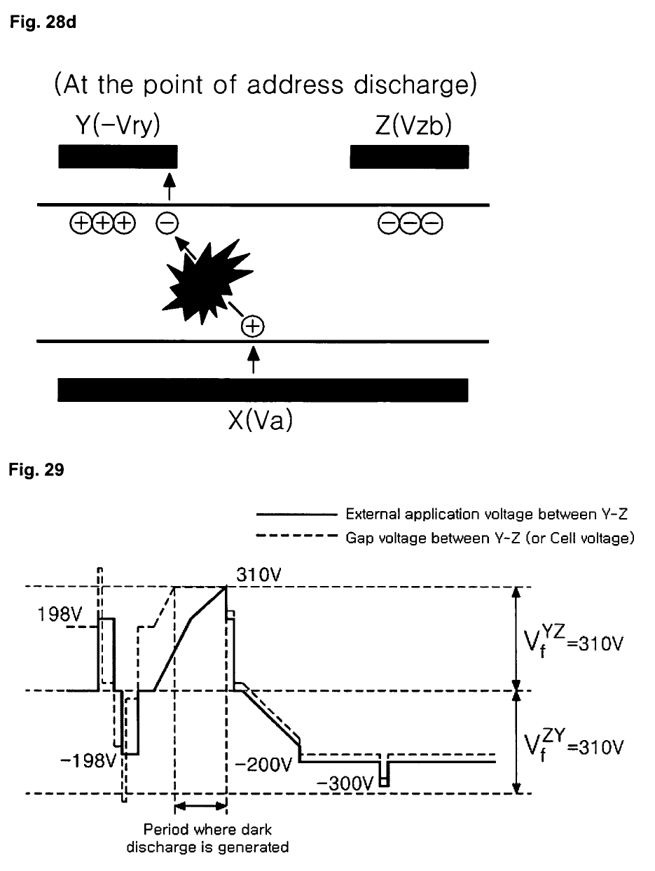

FIG. 27 is a waveform illustrating a portion of a driving waveform applied to sub-fields other than the first sub-field according to the ninth embodiment of the present invention. FIGS. 28a to 28d illustrate the distribution of wall charges within a discharge cell, step by step, which vary depending upon the driving waveform shown in FIG. 27.

Referring to FIG. 27, if a last sustain pulse LSTSUSP having a wide pulse width is applied to the sustain electrodes Z in all of the sub-fields, a sustain discharge is generated between the scan electrodes Y and the sustain electrodes Z. Wall charges of a positive polarity are accumulated on the scan electrodes Y, wall charges of a negative polarity are accumulated on the sustain electrodes Z, and wall charges of a positive polarity are accumulated on the address electrodes X, within a discharge cell, by means of the last sustain discharge, as shown in FIG. 28.

In a set-up period SU of the reset period RP, a first Y positive ramp waveform PRY1 and a second Y positive ramp waveform PRY2 are consecutively applied to all the scan electrodes Y, and 0V are applied to the sustain electrodes Z and the address electrodes X. The voltage of the first Y positive ramp waveform PRY1 rises from 0V to a positive sustain voltage Vs. The voltage of the second Y positive ramp waveform PRY2 rises from the positive sustain voltage Vs up to a positive Y reset voltage Vry. The positive Y reset voltage Vry is lower than the positive Z reset voltage Vrz, and intentionally between the positive Z reset voltage Vrz and the positive sustain voltage Vs. The slope of the second Y positive ramp waveform PRY2 is less than that of the first Y positive ramp waveform PRY1. Due to the first Y positive ramp waveform PRY1 and the voltage associated with the electric field formed between the scan electrodes Y and the sustain electrodes Z within the discharge cell, a dark discharge is generated between the scan electrodes Y and the sustain electrodes Z and between the scan electrodes Y and the address electrodes X in all of the discharge cells. As a result of this discharge, immediately after the set-up period SU, as wall charges of a negative polarity are accumulated on the scan electrodes Y around a gap between the scan electrodes Y and the sustain electrodes Z within all of the discharge cells, as shown in FIG. 28b, the polarity of the wall charges is inverted from a positive polarity to a negative polarity. Thus, more wall charges of a positive polarity are accumulated on the address electrodes X. Furthermore, the wall charges that have accumulated on the sustain electrodes Z are reduced. Specifically, the negative polarity wall charges are reduced toward the scan electrodes Y as shown in FIG. 28b.

In a set-down period SD of the reset period RP, while the second Y negative ramp waveform NRY2 is applied to the scan electrodes Y, a reference voltage GND or 0V is applied to the sustain electrodes Z and the address electrodes X. The voltage of the second Y negative ramp waveform NRY2 drops from a positive sustain voltage Vs to a negative voltage −V2. In the set-down period SD where these driving voltages are applied, the wall charges of a positive polarity are accumulated on the address electrodes X. Thus, a dark discharge is generated only between the scan electrodes Y and the address electrodes X, as shown in FIG. 28c. The dark discharge causes excessive wall charges of a negative polarity, which have been accumulated on the scan electrodes Y, to be erased, and excessive wall charges of a positive polarity, which have been accumulated on the address electrodes X, to be erased. As a result, all of the discharge cells have a uniform wall charge distribution which is optimal for addressing.

In the address period AP, while a negative scan pulse −SCNP is sequentially applied to the scan electrodes Y, a positive data pulse DP is applied to the address electrodes X in synchronism with the scan pulse −SCNP. The voltage of the scan pulse −SCNP is Vsc, which drops from 0V or a negative scan bias voltage Vyb around 0V to a negative scan voltage −Vy. The voltage of the data pulse DP is a positive data voltage Va. During the address period AP, a positive Z bias voltage Vzb, which is lower than the scan voltage Vsc but higher than the positive sustain voltage Vs, is applied to the sustain electrodes Z. Where, immediately after the reset period RP, the gap voltage for all discharge cells is optimally adjusted for addressing, an address discharge is generated only between the scan electrodes Y and the address electrodes X within on-cells to which the scan voltage Vsc and the data voltage Va are applied, as the gap voltage between the electrodes Y and X exceeds the firing voltage Vf. At this time, since the address discharge is generated between one side of the scan electrodes Y near the gap between the scan electrode Y and the sustain electrode Z, and the address electrode X, the discharge delay time shortens. Upon the address discharge, wall charge distribution within the on-cells will change as suggested in FIG. 28d.

Meanwhile, off-cells, in which 0V or the reference voltage is applied to the address electrodes X, or 0V or the scan bias voltage Vyb is applied to the scan electrodes Y have a gap voltage less than the firing voltage. Accordingly, in off-cells there is no address discharge, and wall charge distribution is substantially the same as shown in FIG. 28c.

The sustain period SP is substantially the same as that of the aforementioned embodiments. Thus, a detailed description thereof will be omitted for simplicity.

FIG. 29 shows the difference in an externally applied voltage between the scan electrode Y and the sustain electrode Z, and the discharge cell gap voltage between the scan electrode Y and the sustain electrode Z, assuming that the positive sustain voltage Vs is 80V, the positive Y reset voltage Vry is 180V, the negative scan bias voltage −Vy is 200V, and the Z bias voltage Vzb is 100V in the driving waveform of FIG. 27. In FIG. 29, V_{f}^{yz} and V_{f}^{zy} indicate the firing voltages between the scan electrodes Y and the sustain electrodes Z.

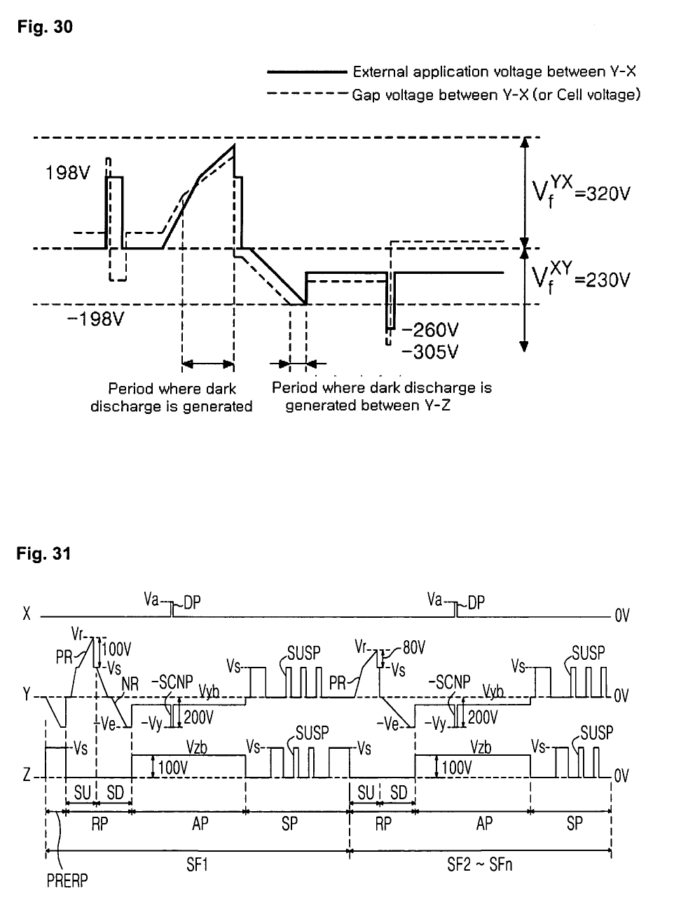

FIG. 30 shows the difference in an externally applied voltage between the scan electrode Y and the sustain electrode Z, and a discharge cell gap voltage between the scan electrode Y and the sustain electrode Z, assuming that the positive sustain voltage Vs is 80V, the positive Y reset voltage Vry is 180V, the negative scan bias voltage −Vy is 200V, and the Z bias voltage Vzb is 100V in the driving waveform of FIG. 27. In FIG. 30, V_{f}^{yx} and V_{f}^{xy} indicate the firing voltages between the scan electrodes Y and the address electrodes X.

FIG. 31 shows a driving waveform for a plasma display apparatus according to a tenth embodiment of the present invention. Referring to FIG. 31, an erase discharge does not exist between a sustain period SP and a reset period RP. A set-down discharge and an address discharge are generated using wall charges of a positive polarity, which are accumulated on the address electrodes by means of a sustain discharge generated in every sub-field. Further, according to the method of driving the plasma display apparatus in accordance with the present invention, during a set-down period SD, the voltage of the sustain electrodes Z is maintained at a reference voltage GND or 0V, and the wall charges accumulated on the address electrode X in all of the sub-fields are used. Therefore, the set-down discharge and the address discharge are generated only between the scan electrode Y and the address electrode X.

Furthermore, wall charges are sufficiently accumulated within respective discharge cells before the set-up period SD. Thus, the reset voltage Vry can be lowered in sub-fields SF2 to SFn. Moreover, during sub-fields SF2 to SFn, a set-up discharge can be generated in all the discharge cells using only the sustain voltage Vs, without increasing voltage up to the reset voltage Vry.

As a result of applying the driving waveform of FIG. 31 to a PDP, it was found that an address discharge delay value, i.e., a jitter value, is significantly reduced for the subsequent sub-fields. Furthermore, as shown in FIG. 31, in the pre-reset period PRERP of the first sub-field, a positive bias voltage VS (square type wave) is applied to the sustain electrodes, while a first Y negative ramp wave NRY1 is applied to the scan electrodes, in the same manner as FIG. 15. Moreover, in the set-up period SU of the reset period, after a first Y positive ramp waveform PRY1 and a second Y positive ramp waveform PRY2 are consecutively applied to the scan electrodes, a second Y negative ramp waveform NRY2 is applied during the set-down period SD. In the present embodiment, in the set-down period SD, the sustain electrodes are kept to 0V or the reference voltage.

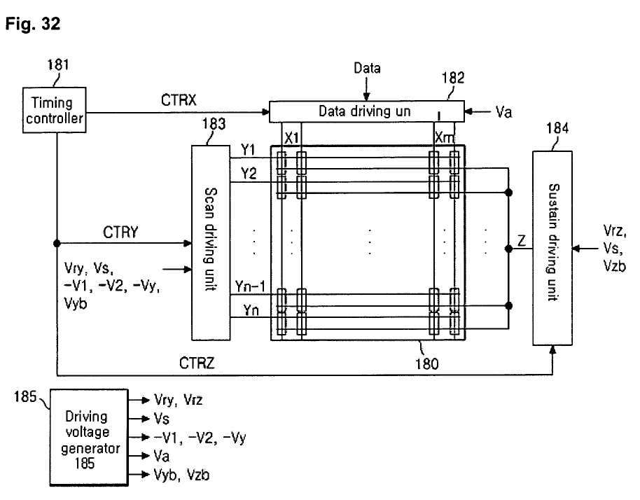

FIG. 32 is a block diagram illustrating the configuration of a plasma display apparatus according to the exemplary embodiments of the present invention. Referring to FIG. 32, the plasma display apparatus according to an embodiment of the present invention includes a PDP 180, a data driving unit 182 for supplying data to address electrodes X1 to Xm of the PDP 180, a scan driving unit 183 for driving scan electrodes Y1 to Yn of the PDP 180, a sustain driving unit 184 for driving a sustain electrode Z of the PDP 180, a timing controller 181 for controlling the respective driving units 182, 183 and 184, and a driving voltage generator 185 for generating driving voltages necessary for the respective driving units 182, 183 and 184.

FIG. 32 is a block diagram illustrating the configuration of a plasma display apparatus according to the exemplary embodiments of the present invention. Referring to FIG. 32, the plasma display apparatus according to an embodiment of the present invention includes a PDP 180, a data driving unit 182 for supplying data to address electrodes X1 to Xm of the PDP 180, a scan driving unit 183 for driving scan electrodes Y1 to Yn of the PDP 180, a sustain driving unit 184 for driving a sustain electrode Z of the PDP 180, a timing controller 181 for controlling the respective driving units 182, 183 and 184, and a driving voltage generator 185 for generating driving voltages necessary for the respective driving units 182, 183 and 184.

Though not shown in the data driving unit 182, data, which experiences inverse gamma correction and error diffusion through an inverse gamma correction circuit, an error diffusion circuit, etc., is mapped to a predetermined sub-field pattern through a sub-field mapping circuit. The data driving unit 182 applies 0V or the reference voltage to the address electrodes X1 to Xm during the pre-reset period PRERP, the reset period RP and the sustain period SP, as in FIGS. 6, 8, 14 to 26, 27, and 31. Further, the data driving unit 182 can supply a positive bias voltage from the driving voltage generator 185, such as the data voltage Va, to the address electrodes X1 to Xm in the set-down period SD of the reset period RP, as in FIGS. 24 and 25. Moreover, the data driving unit 182 samples and latches data, and supplies the sampled data to the address electrodes X1 to Xm during the address period AP, under the control of the timing controller 181.

The scan driving unit 183 supplies the ramp waveforms NRY1, PRY1, PRY2 and NRY2 to the scan electrodes Y1 to Yn in order to initialize all of the discharge cells during the pre-reset period PRERP and the reset period RP, and then sequentially supplies the scan pulse SCNP to the scan electrodes Y1 to Yn in order to select scan lines from which data is supplied during the address period AP, under the control of the timing controller 181, as in FIGS. 6, 8, 14 to 26, 27 and 31. Furthermore, the scan driving unit 183 supplies the sustain pulses FSTSUSP, SUSP to the scan electrodes Y1 to Yn so that a sustain discharge can be generated within selected on-cells during the sustain period SP.

The sustain driving unit 184 supplies the ramp waveforms PRZ, NRZ1 and NRZ2 to the sustain electrodes Z in order to initialize all of the discharge cells during the pre-reset period PRERP and the reset period RP, and then supplies the Z bias voltage Vzb to the sustain electrodes Z during the address period AP, under the control of the timing controller 181, as in FIGS. 6, 8, 14 to 26, 27 and 31. Further, the sustain driving unit 184 supplies the sustain pulses FSTSUSP, SUSP and LSTSUSP to the sustain electrodes Z during the sustain period SP, while alternately operating with the scan driving unit 183.

The timing controller 181 receives vertical and horizontal sync signals and a clock signal to generate the timing control signals CTRX, CTRY and CTRZ necessary for the respective driving units 182, 183 and 184, and supplies the timing control signals CTRX, CTRY and CTRZ to corresponding driving units 182, 183 and 184, thus controlling the respective driving units 182, 183 and 184. The timing control signals CTRX supplied to the data driving unit 182 includes a sampling clock for sampling data, a latch control signal, and a switch control signal for controlling on/off time of an energy recovery circuit and a driving switch element. The timing control signals CTRY applied to the scan driving unit 183 includes a switch control signal for controlling on/off time of an energy recovery circuit and a driving switch element within the scan driving unit 183. Furthermore, the timing control signals CTRZ applied to the sustain driving unit 184 include a switch control signal for controlling on/off time of an energy recovery circuit and a driving switch element within the sustain driving unit 184.

The driving voltage generator 185 generates driving voltages supplied to the PDP 180, i.e., Vry, Vrz, Vs, −V1, −V2, −Vy, Va, Vyb, Vzb, and the like, shown in FIGS. 6, 8, 14 to 26, 27 and 31. Meanwhile, these driving voltages can vary depending upon a discharge characteristic that varies depending upon resolution, model, etc. of the PDP 180, or composition of a discharge gas.

As described above, according to a plasma display apparatus and method of driving the same in accordance with the present invention, before discharge cells are initialized, wall charges of a positive polarity are sufficiently accumulated on the scan electrodes within the discharge cells, and wall charges of a negative polarity are sufficiently accumulated on the sustain electrodes. Therefore, erroneous discharge, miss-discharge and abnormal discharge can be prevented and the total number of discharges generated during the initialization process can be also reduced. Accordingly, the present invention is advantageous in that it can increase dark room contrast and widen operational margin. Furthermore, according to the present invention, the voltage of a negative ramp waveform, which is generated during a set-down period SD, is lowered from 0V or a reference voltage. Thus, adequate driving time is secured by reducing the set-down period SD. In addition, the discharge time of the dark discharge, generated between the scan electrodes and the address electrodes, is made longer by applying a positive bias voltage to the address electrodes during the set-down period SD. Therefore, wall charge distribution within all of the discharge cells can be made uniform.

Furthermore, according to a plasma display apparatus and method of driving the same in accordance with the present invention, before a reset period RP, sufficient wall charges are formed within discharge cells, and a set-up discharge is thus generated in all discharge cells within a sustain voltage. It is thus possible to lower the reset voltage necessary for the set-up operation. Moreover, during a set-down period SD and an address period, a discharge is generated only between scan electrodes and address electrodes. The time necessary for address discharge can thus be reduced.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A plasma display apparatus including surface discharge electrode pairs, each having a first electrode and a second electrode, third electrodes that intersect the surface discharge electrode pairs, and a plurality of discharge cells, each disposed at the intersection of a surface discharge electrode pair and a third electrode, the plasma display apparatus comprising:
a first driving unit for applying a first waveform to a first electrode during a pre-reset period prior to a reset period, applying a first ramp waveform having an opposite polarity direction to that of the first waveform to the first electrode in the reset period, and then applying a second ramp waveform having an opposite polarity direction to that of the first ramp waveform to the first electrode; and
a second driving unit for applying a second waveform having an opposite polarity direction to that of the first waveform to a second electrode during the pre-reset period, and applying a third ramp waveform of the same polarity direction as that of the second ramp waveform to the second electrode in synchronization with the second ramp waveform in the reset period.

2. The plasma display apparatus as claimed in claim 1, wherein the first ramp waveform includes a first portion having a first slope, and a second portion having a second slope that is less than the first slope.

3. The plasma display apparatus as claimed in claim 1, wherein a voltage of the first ramp waveform is less than a voltage of the second waveform.

4. The plasma display apparatus as claimed in claim 2, wherein the second waveform includes a first waveform portion that varies from a first voltage to a second voltage, and wherein a maximum voltage of the first ramp waveform is less than the second voltage.

5. The plasma display apparatus as claimed in claim 1, wherein wall charges are accumulated on the first and second electrodes during the pre-reset period, and wherein the polarity of the wall charges for at least one of the first and second electrodes is maintained during the reset period.

6. The plasma display apparatus as claimed in claim 1, wherein wall charges are accumulated on the first and second electrodes during the pre-reset period, and wherein two or more discharges are generated within the discharge cells during the reset period, and wherein the polarity of the wall charges accumulated on at least one of the first and second electrodes is maintained during the reset period.

7. The plasma display apparatus as claimed in claim 1, wherein the first and second driving units apply voltages to the first and second electrodes in order to cause a dark discharge to occur only between the first and third electrodes during a set-down period of the reset period.

8. The plasma display apparatus as claimed in claim 1, further comprising a third driving unit that applies a data pulse to the third electrode during an address period,
wherein the first, second and third driving units apply voltages to the first, second and third electrodes, respectively, in order to cause a dark discharge to occur only between the first and third electrodes during the address period.

9. The plasma display apparatus as claimed in claim 1, further comprising a third driving unit that applies a data pulse to the third electrode during an address period,
wherein the first driving unit applies a scan pulse to the first electrode during the address period, and
wherein the second driving unit applies a bias voltage, which is lower than the voltage associated with the scan pulse and has an opposite polarity direction to that of the scan pulse voltage, and applies a voltage to the first to third electrodes in order to cause a dark discharge to occur only between the first and third electrodes during the address period.

10. The plasma display apparatus as claimed in claim 1 wherein the first and second driving units apply waveforms to the first and the second electrodes, respectively, during each of a plurality of sub-fields, and wherein at least one of the plurality of sub-fields includes a reset period and a sustain period.

11. The plasma display apparatus as claimed in claim 10, wherein the first and second driving units omit the pre-reset period in at least one of the plurality of sub-fields.

12. The plasma display apparatus as claimed in claim 10, wherein there is no erase period between a sustain period and a next reset period in at least one of the plurality of sub-fields other than the first sub-field.

13. The plasma display apparatus as claimed in claim 10, wherein the first and second driving units alternately apply a sequence of sustain pulses to the first and second electrodes respectively during the sustain period of a given sub-field, and wherein the last sustain pulse has a pulse width that is greater than the pulse width of one or more prior sustain pulses.

14. A plasma display apparatus including surface discharge electrode pairs, each having a first electrode and a second electrode, third electrodes that intersect the surface discharge electrode pairs, and a plurality of discharge cells, each disposed at the intersection of a surface discharge electrode pair and a third electrode, the plasma display apparatus comprising:
a first driving unit for applying, during a pre-reset period prior to a reset period, a first waveform to a first electrode, and during the reset period, applying a first ramp waveform of opposite polarity direction to that of the first waveform to the first electrode and then applying a second ramp waveform of opposite polarity direction to that of the first ramp waveform to the first electrode; and
a second driving unit for applying a second waveform of opposite polarity direction to that of the first waveform to a second electrode during the pre-reset period, and applying a third ramp waveform having the same polarity direction as that of the second ramp waveform to the second electrode in synchronization with the second ramp waveform during the reset period,
wherein the first and second driving units apply waveforms to the first and second electrodes in each of a plurality of sub-fields, wherein a single frame includes a plurality of sub-fields, and
wherein the pre-set period occurs in at least one of the plurality of sub-fields in a single frame.

15. The plasma display apparatus as claimed in claim 14, wherein the plasma display apparatus further comprises a display panel, and when the first waveform is applied to the first electrode during the pre-set period and the second waveform is applied to the second electrode, the interior of said display panel is at least 40° C.

16. A plasma display apparatus including surface discharge electrode pairs, each having a first electrode and a second electrode, third electrodes that intersect the surface discharge electrode pairs, and a plurality of discharge cells, each disposed at the intersection of a surface discharge electrode pair and a third electrode, the plasma display apparatus comprising:
a first driving unit for applying, during a pre-reset period prior to a reset period, a first waveform to a first electrode, and during the reset period, applying a first ramp waveform of opposite polarity direction to that of the first waveform to the first electrode and then applying a second ramp waveform of opposite polarity direction to that of the first ramp waveform to the first electrode; and
a second driving unit for applying, during the pre-reset period, a second waveform of opposite polarity direction to that of the first waveform to a second electrode, and applying, during the reset period, a third ramp waveform having the same polarity direction as that of the second ramp waveform in synchronization with the second ramp waveform,
wherein the third ramp waveform reaches and is maintained at a reference voltage before the second ramp waveform reaches a reference voltage.

17. A plasma display apparatus including surface discharge electrode pairs, each having a first electrode and a second electrode, third electrodes that intersect the surface discharge electrode pairs, and a plurality of discharge cells, each disposed at the intersection of a surface discharge electrode pair and a third electrode, the plasma display apparatus comprising:
a first driving unit for applying, during a pre-reset period prior to a reset period, a first waveform to the first electrode, and during the reset period, applying a first ramp waveform of opposite polarity direction to that of the first waveform to the first electrode and then applying a second ramp waveform of opposite polarity direction to that of the first ramp waveform to the first electrode; and
a second driving unit for applying, during the pre-reset period, a first square type wave of opposite polarity direction to that of the first waveform to the second electrode, and applying, during the reset period, a second square type wave of opposite polarity direction to that of the second ramp waveform.

18. The plasma display apparatus as claimed in claim 17, wherein the first waveform is applied to the first electrode within a period of time where the first square type wave is applied to the second electrode.

19. The plasma display apparatus as claimed in claim 17, wherein the second driving unit applies the first square type wave to the second electrode before the first driving unit applies the first ramp waveform to the first electrode.

20. The plasma display apparatus as claimed in claim 17, wherein the voltage of the second square type wave is less than the voltage of the first square type wave.

21. The plasma display apparatus of claim 17, wherein the first and second driving units apply waveforms to the first and second electrodes, respectively, during each of a plurality of sub-fields, and wherein at least one sub-field includes a sustain period.

22. The plasma display apparatus as claimed in claim 21, wherein the first and second driving units alternately apply a sequence of sustain pulses to the first and second electrodes during a sustain period in a given sub-field,
wherein the last sustain pulse has a pulse width that is greater than the pulse width of at least one preceding sustain pulse, and
where in at least one sub-field after the first sub-field, the first and second driving units omit the pre-reset period, the first driving unit applies the second ramp waveform from a reference voltage during the reset period, and the second driving unit omits the second square type wave during the reset period.

23. A plasma display apparatus including surface discharge electrode pairs, each having a first electrode and a second electrode, third electrodes that intersect the surface discharge electrode pairs, and a plurality of discharge cells, each disposed at the intersection of a surface discharge electrode pair and a third electrode, the plasma display apparatus comprising:
a first driving unit for applying, during in a pre-reset period prior to a reset period, a first waveform to a first electrode, and during the reset period, applying a first ramp waveform of opposite polarity direction to that of the first waveform to the first electrode and then applying a second ramp waveform of opposite polarity direction to that of the first ramp waveform to the first electrode; and
a second driving unit for applying, during the pre-reset period, a first square type wave of opposite polarity direction to that of the first waveform to a second electrode, and applying during the reset period, a second square type wave of opposite polarity direction to that of the second ramp waveform,
wherein a voltage level of the first waveform is at least the same as that of the second ramp waveform.

24. The plasma display apparatus as claimed in claim 23, wherein the voltage level of the first waveform is equal to that of the second ramp waveform.

25. The plasma display apparatus as claimed in claim 23 further comprising a voltage source, wherein the voltage source generates the voltage necessary for the first waveform and the second ramp waveform.

26. The plasma display apparatus as claimed in claim 23, wherein a voltage level of the first square type wave is greater than a bias voltage applied to the second electrode during an address period subsequent to the reset period.

27. A plasma display apparatus including surface discharge electrode pairs, each having a first electrode and a second electrode, third electrodes that intersect the surface discharge electrode pairs, and a plurality of discharge cells, each disposed at the intersection of a surface discharge electrode pair and a third electrode, the plasma display apparatus comprising:
a first driving unit for applying, during a pre-reset period prior to a reset period, a reference voltage to a first electrode, and during the reset period, applying a first ramp waveform to the first electrode and then applying a second ramp waveform of opposite polarity direction to that of the first ramp waveform to the first electrode; and
a second driving unit for applying, during the pre-reset period, a third ramp waveform having the same polarity direction as that of the first waveform to a second electrode and thereafter applying a fourth ramp waveform having the same polarity direction as that of the second waveform to the second electrode, and, during the reset period, applying a fifth ramp waveform having the same polarity direction as that of the second ramp waveform to the second electrode.

28. A plasma display apparatus including surface discharge electrode pairs, each having a first electrode and a second electrode, third electrodes that intersect the surface discharge electrode pairs, and a plurality of discharge cells, each disposed at the intersection of a surface discharge electrode pair and a third electrode, the plasma display apparatus comprising:
a first driving unit for applying, during a pre-reset period prior to a reset period, a first waveform to a first electrode, and during the reset period, applying a first ramp waveform of opposite polarity direction to that of the first waveform to the first electrode and then applying a second ramp waveform of opposite polarity direction to that of the first ramp waveform to the first electrode; and
a second driving unit for applying a reference voltage to a second electrode during the pre-reset period, and applying, during the reset period, a third ramp waveform having the same polarity direction as that of the second ramp waveform to the second electrode.

29. A plasma display apparatus including surface discharge electrode pairs, each having a first electrode and a second electrode, third electrodes that intersect the surface discharge electrode pairs, and a plurality of discharge cells, each disposed at the intersection of a surface discharge electrode pair and a third electrode, the plasma display apparatus comprising:
a first driving unit for applying, during a pre-reset period prior to a reset period, a first waveform to a first electrode, and during the reset period, applying a first ramp waveform of opposite polarity direction to that of the first waveform to the first electrode and then applying a second ramp waveform of opposite polarity direction to that of the first ramp waveform to the first electrode wherein the second ramp waveform starts from a reference voltage; and
a second driving unit for applying, during the pre-reset period, a second waveform of opposite polarity direction to that of the first waveform to a second electrode, and applying, during the reset period, a third ramp waveform having the same polarity direction as that of the second ramp waveform to the second electrode.

30. A plasma display apparatus including surface discharge electrode pairs, each having a first electrode and a second electrode, third electrodes that intersect the surface discharge electrode pairs, and a plurality of discharge cells, each disposed at the intersection of a surface discharge electrode pair and a third electrode, the plasma display apparatus comprising:
a first driving unit for applying, during a pre-reset period prior to a reset period, a first waveform to a first electrode, and during the reset period, applying a first ramp waveform of opposite polarity direction to that of the first waveform to the first electrode and then applying a second ramp waveform of opposite polarity direction to that of the first ramp waveform to the first electrode, wherein the second ramp waveform starts from a reference voltage; and
a second driving unit for applying, during the pre-reset period, a second waveform having an opposite polarity direction to that of the first waveform to a second electrode, and applying a reference voltage to the second electrode during the reset period.

31. A plasma display apparatus including surface discharge electrode pairs, each having a first electrode and a second electrode, third electrodes that intersect the surface discharge electrode pairs, and a plurality of discharge cells, each disposed at the intersection of a surface discharge electrode pair and a third electrode, the plasma display apparatus comprising:
a first driving unit for applying a first waveform to a first electrode during a pre-reset period prior to a reset period, applying a first ramp waveform of opposite polarity direction to that of the first waveform to the first electrode during the reset period, and then applying a second ramp waveform of opposite polarity direction to that of the first ramp waveform to the first electrode; and
a second driving unit for applying a second waveform of opposite polarity direction to that of the first waveform to a second electrode during the pre-reset period, and applying a third ramp waveform having the same polarity direction as that of the second ramp waveform to the second electrode during the reset period; and
a third driving unit for applying a third square type wave of opposite polarity direction to that of the second ramp waveform to a third electrode in synchronization with the second ramp waveform during the reset period.

32. A plasma display apparatus including surface discharge electrode pairs, each having a first electrode and a second electrode, third electrodes that intersect the surface discharge electrode pairs, and a plurality of discharge cells, each disposed at the intersection of a surface discharge electrode pair and a third electrode, the plasma display apparatus comprising:
a first driving unit for applying, during a pre-reset period prior to a reset period, a first waveform to a first electrode, and during the reset period, applying a first ramp waveform of opposite polarity direction to that of the first waveform the first electrode and then applying a second ramp waveform of opposite polarity direction to that of the first ramp waveform to the first electrode; and
a second driving unit for applying, during the pre-reset period, a second waveform of opposite polarity direction to that of the first waveform to a second electrode, and applying, during the reset period, a reference voltage to the second electrode.

33. The plasma display apparatus as claimed in claim 32, wherein the first and second driving units apply voltages to the first and second electrodes during a set-up period of the reset period thereby causing a dark discharge to occur between a lateral portion of the first electrode and the third electrode during a set-down period of the reset period, by inverting the polarity of wall charges associated with the first electrode in a lateral portion of the second electrode.

34. The plasma display apparatus as claimed in claim 32, further comprising a third driving unit for applying a data pulse to the third electrode during an address period,
wherein the first, second and third driving units apply voltages to the first, second and third electrodes, respectively, thereby causing a dark discharge to occur between a lateral portion of the first electrode, closest to the second electrode, and the third electrode during the address period.

35. The plasma display apparatus as claimed in claim 32, wherein the first and second driving units apply waveforms to the first and second electrodes, respectively, during each of a plurality of sub-fields, and wherein at least one sub-field includes a sustain period and a reset period.

36. The plasma display apparatus as claimed in claim 35, wherein the first and second driving units alternately apply sustain pulses to the first and second electrodes during the sustain periods,
wherein the last sustain pulse of the sustain period has a pulse width that is greater than the pulse width associated with at least one preceding sustain pulse, and
where in at least one of the plurality of sub-fields, the first and second driving units omit the pre-reset period, and the first driving unit applies the second ramp waveform beginning from a reference voltage during the reset period.

37. A plasma display apparatus including surface discharge electrode pairs, each having a first electrode and a second electrode, third electrodes that intersect the surface discharge electrode pairs, and a plurality of discharge cells, each disposed at the intersection of a surface discharge electrode pair and a third electrode, the plasma display apparatus comprising:
a first driving unit for applying, during a pre-reset period prior to a reset period, a first waveform to a first electrode, and during the reset period, applying a first ramp waveform of opposite polarity direction to that of the first waveform to the first electrode, and then applying a second ramp waveform of opposite polarity direction to that of the first ramp waveform to the first electrode; and
a second driving unit for applying, during the pre-set period, a first square type wave having an opposite polarity direction to that of the first waveform to a second electrode during the pre-reset period, and applying a reference voltage to the second electrode during the reset period.

38. A plasma display apparatus, comprising:
a first substrate including at least one electrode;
a second substrate including at least one electrode; and
a plurality of discharge cells disposed between the first substrate and the second substrate,
wherein a first waveform is applied to the first substrate during a pre-reset period, which is prior to a reset period initializing the discharge cells, and a second waveform having an opposite polarity direction to that of the first waveform is applied to the first substrate to initialize the discharge cells in the reset period.

39. A plasma display apparatus, comprising:
a first substrate including at least one electrode;
a second substrate including at least one electrode; and
a plurality of discharge cells disposed between the first substrate and the second substrate,
wherein a first waveform and a second waveform, having an opposite polarity direction to that of the first waveform, are applied to the first substrate during a pre-reset period which is prior to a reset period initializing the discharge cells, and a third waveform having an opposite polarity direction to that of the first waveform is applied to the first substrate to initialize the discharge cells during the reset period.

40. A plasma display apparatus, comprising:
a first substrate including at least one electrode;
a second substrate including at least one electrode; and
a plurality of discharge cells disposed between the first substrate and the second substrate,
wherein a first waveform is applied to the first substrate during a pre-reset period which is prior to a reset period initializing the discharge cells, and
a second waveform having an opposite polarity direction to that of the first waveform is applied to the first substrate to initialize the discharge cells during the reset period while at least one electrode maintains the polarity of charges accumulated in at least one electrode of the first substrate during the pre reset period.

41. A plasma display apparatus comprising:
a first substrate including at least one electrode;
a second substrate including at least one electrode; and
a plurality of discharge cells disposed between the first substrate and the second substrate,
wherein a reference voltage is applied to at least one electrode of the first substrate during the reset period initializing the discharge cells.

42. The plasma display apparatus of claim 41, wherein the reference voltage is 0 v or ground (GND) level voltage.

43. A method of driving a plasma display apparatus including first and second substrates respectively having at least one electrode, and a plurality of discharge cells disposed between the first substrate and the second substrate, comprising the steps of:
applying a first waveform to the first substrate during a pre-reset period which is prior to a reset period initializing the discharge cells; and
applying a second waveform having an opposite polarity direction to that of the first waveform to the first substrate to initialize the discharge cells during the reset period.

44. A method of driving a plasma display apparatus including first and second substrates respectively having at least one more electrode, and a plurality of discharge cells disposed between the first substrate and the second substrate, comprising the steps of:
direction to that of the first waveform, to the first substrate during a pre-reset period which is prior to a reset period initializing the discharge cells; and
applying a third waveform having an opposite polarity direction to that of the first waveform to the first substrate to initialize the discharge cells during the reset period.

45. A method of driving a plasma display apparatus including first and second substrates respectively having at least one electrode, and a plurality of discharge cells disposed between the first substrate and the second substrate, comprising the steps of:
applying a first waveform to the first substrate during a pre-reset period which is prior to a reset period initializing the discharge cells, and
applying a second waveform, having an opposite polarity direction to that of the first waveform, to the first substrate to initialize the discharge cells during the reset period while at least one electrode associated with the first substrate maintains polarity of charges accumulated during the pre-reset period.

46. A method of driving a plasma display apparatus including first and second substrates respectively having at least one electrode, and a plurality of discharge cells disposed between the first substrate and the second substrate,
wherein a reference voltage is applied to at least one electrode associated with the first substrate during a reset period initializing the discharge cells.

47. The method of claim 46, wherein the reference voltage is 0v or ground (GND) level voltage.

48. A plasma display apparatus, comprises:
a first electrode to which a first waveform is applied during a pre-reset period prior to a reset period; and
a second electrode to which a second waveform having an opposite polarity direction to that of the first waveform is applied during the pre-reset period.

49. The plasma display apparatus as claimed in claim 48, wherein waveforms are applied to the first and second electrodes during each of a plurality of sub-fields, wherein each sub-field includes a reset period and an address period after the reset period, and wherein a bias voltage is applied to the second electrode after the reset period and before a first scan pulse applied to the first electrode during the address period.

50. The plasma display apparatus as claimed in claim 48, wherein the first waveform is a negative voltage waveform, and the second waveform is a positive voltage waveform.

51. The plasma display apparatus as claimed in claim 48, wherein the first waveform is applied to the first electrode during the period of time that the second waveform is applied to the second electrode.

52. The plasma display apparatus as claimed in claim 48, wherein the first waveform includes a first pulse having a first slope.

53. The plasma display apparatus as claimed in claim 48, wherein the second waveform is a square type wave having a voltage that changes from 10% to 90% of the maximum voltage in less than 10 μs.

54. The plasma display apparatus as claimed in claim 48, wherein the first waveform is a square type wave having a voltage that changes from 10% to 90% of the maximum voltage in less than 10 μs.

55. The plasma display apparatus as claimed in claim 48, wherein the second waveform includes a period where the voltage gradually changes.

56. The plasma display apparatus as claimed in claim 48, wherein the reset period includes a second ramp pulse having a positive slope to be applied to the first electrode, a third ramp pulse having a positive slope that is less than the slope of the second ramp pulse, is applied to the first electrode.

57. The plasma display apparatus as claimed in claim 52, wherein the first slope is substantially equal to the slope of at least one pulse during the reset period.

58. The plasma display apparatus as claimed in claim 47, wherein a voltage of the second waveform is greater than the bias voltage.

59. The plasma display apparatus as claimed in claim 48, wherein a voltage of the first waveform is substantially equal to a scan pulse voltage applied to the first electrode during the address period.

60. The plasma display apparatus as claimed in claim 48, wherein a voltage of the second waveform is substantially equal to a voltage that is applied to the second electrode during a sustain period subsequent the address period.

61. The plasma display apparatus as claimed in claim 48, where in the pre-reset period, wall charges of a positive polarity increase in the first electrode, and wall charges of a negative polarity increase in the second electrode and during the reset period, wall charges of a positive polarity decrease in the first electrode and the wall charges of a negative polarity decrease in the second electrode.

62. The plasma display apparatus as claimed in claim 48, where in the reset period, wall charges of a positive polarity decrease in the first electrode and the wall charges of a negative polarity decrease in the second electrode.

63. The plasma display apparatus as claimed in claim 48, wherein the pre-reset period is omitted from at least one of a plurality of sub-fields.

64. The plasma display apparatus as claimed in claim 48, wherein maximum voltage applied to the first electrode during the reset period of one sub-field is greater than or substantially equal to a maximum voltage applied to the first electrode during the reset period of another sub-field.

65. The plasma display apparatus as claimed in claim 48, where during the reset period of one sub-field voltage more abruptly drops from a predetermined reference voltage to 0V or to a ground (GND) voltage level compared to the reset period of another sub-field.

66. The plasma display apparatus as claimed in claim 48, wherein the reference voltage is substantially equal to a voltage associated with sustain pulses having positive polarity, which are applied during a sustain period subsequent to the address period.

67. The plasma display apparatus as claimed in claim 48, wherein the plasma display apparatus further comprises a display panel, and when the first waveform is applied to the first electrode during the pre-set period and the second waveform is applied to the second electrode, the interior of said display panel is at least 40° C.
